(19) United States
(12) Patent Application Publication
(10) Pub. No.: US 2015/0082314 A1
(43) Pub. Date: Mar. 19, 2015

(54) TASK PLACEMENT DEVICE, TASK PLACEMENT METHOD AND COMPUTER PROGRAM

(71) Applicant: NEC Corporation, Tokyo (JP)

(72) Inventor: Noriaki Suzuki, Tokyo (JP)

(21) Appl. No.: 14/394,419

(22) PCT Filed: Apr. 16, 2013
(86) PCT No.: PCT/JP2013/002551

§ 371 Date: Oct. 14, 2014

(30) Foreign Application Priority Data
Apr. 18, 2012 (JP) 2012-094392

(51) Int. Cl. G06F 9/48; G06F 9/54

(52) U.S. Cl. CPC G06F 9/4881; G06F 9/54
USPC 718/102

(57) ABSTRACT

The task placement device includes: a task set parameter acquisition section which acquires task set parameters including information indicating the dependence relationship among tasks contained in a task set, and a required execution time needed for execution of each task; a first task placement section configured to, for a task which is capable of being executed within a scheduling-anticipated period, determine core allocation, taking into consideration scheduling based on the task set parameters; and a second task placement section configured to, for a task except first task placed by the first task placement section, determine the core allocation based on the task set parameters.

### TECHNICAL FIELD

The present invention relates to a task placement device, a task placement method and a computer program each for a multi-core system employing an asymmetric multi-processing (AMP) method.

### BACKGROUND ART

Recently, demands for realization of high performance and low power consumption with respect to digital electronic devices have been grown, and a multi-core configuration which allows a plurality of processor cores (hereinafter, each also referred to as just a “core”) to be incorporated in a built-in large scale integration (LSI) has been drawing attention. Technologies for leveraging this multi-core-built-in LSI have become important in, for example, a real time system aimed at system control. Such a multi-core system is generally classified into a system employing a symmetric multi-processing (SMP) method and a system employing the AMP method.

This SMP method provides a configuration which allows each of tasks to be executed on any one of cores by performing task switching in accordance with availability states of the individual cores, priority levels of currently running tasks, and the like. Thus, the SMP method makes it possible to realize dynamic load distribution and improve the performance of the whole of a system. In such dynamic load distribution, nevertheless, it is difficult to foresee real time performance. Accordingly, the SMP method is not suitable for being applied to real time systems.

In contrast, the AMP method provides a function-distribution type configuration in which each of tasks is executed on only specific cores. Thus, the AMP method is suitable for, for example, a real time system for which it is important to be able to foresee the behavior of the system, as well as a system in which cores to which a specific hardware component is connected are restricted.

In a multi-core system employing such an AMP method, its performance is different depending on which one of cores each of tasks is placed onto. For this reason, in such a multi-core system employing the AMP method, in order to obtain an optimum task execution state, it is necessary to search for various tasks placement patterns to determine an optimum task placement pattern.

For example, as a method for determining a task placement pattern on a plurality of cores, there is list scheduling for use in a parallelized compiler. A list scheduling device performs core allocations of tasks and task scheduling on individual cores while off-line in order to minimize an amount of execution time of a task set on multi-cores. Here, the “while off-line” means “while design or compiling is performed”. Such a list scheduling method is suitable for a system, such as a parallelized compiler, in which task placement processing as well as task scheduling on individual cores is fixedly performed.

Meanwhile, in a multi-core system employing the AMP method, sometimes, a real time operating system (RTOS) operating on each of cores dynamically performs scheduling for determining when which of tasks is to be operated on the core.

In patent literature (PTL) 1, there is disclosed a device which supports such task placement processing for multi-cores. The device disclosed in PTL 1 firstly acquires pieces of information each related to a granular entity allocated to a corresponding one of cores (i.e., pieces of granular entity information). Here, this granular entity is, for example, a unit of processor's processing, and is a collective term of a task, a function, a process constituting a function, and the like. Next, this device calculates a total appearance number for each of tasks or each of functions included in tasks on the basis of the acquired pieces of granular entity information, and generates pieces of information each related to the calculated total appearance number (i.e., pieces of structure information). Further, this device generates, for each of the tasks or the functions included in the tasks, pieces of information each related to a dependency on a corresponding one of other tasks or functions (i.e., pieces of dependency information) on the basis of the acquired pieces of granular entity information. Further, this device indicates pieces of information representing dependency relations existing among mutually different cores (i.e., dependencies among cores) on the basis of the pieces of granular entity information, the pieces of structure information and the pieces of dependency information. Through this configuration, the device disclosed in PTL 1 provides developers with assistance which makes it possible for the developers to determine a task placement pattern which reduces the number of dependencies among cores to a greater degree.

### CITATION LIST

### Patent Literature

[PTL 1]
Japanese Unexamined Patent Application Publication No. 2007-264734

### SUMMARY OF INVENTION

### Technical Problem

Nevertheless, there is a case where a task placement device utilizing the device disclosed in PTL 1 cannot reduce an amount of core idle time sufficiently. Here, this core idle time means a waste time when a core is not performing any process. Hereinafter, this reason will be described.

The device disclosed in PTL 1 provides assistance which allows task placement processing for minimizing the number of dependencies among cores. The existence of such dependencies among cores is likely to become a factor which causes the core idle time. For example, although a certain core is an available state in which the core can execute a task, a task having been placed on the core needs to wait for the completion of execution of a task running on a different core, and thus, the core cannot execute the task. Further, even though scheduled execution clock times of tasks on individual cores are changed when the tasks are actually executed, it is a permanently applicable attribute that the number of dependencies among cores is small. Accordingly, even for a system in which task scheduling on individual cores is dynamically controlled, through the minimization of the number of dependencies among cores, the device disclosed in PTL 1 can bring about an advantageous effect to some extent in reduction of an amount of core idle time caused by dependency waiting states.

Nevertheless, there is also a case where an amount of core idle time is not sufficiently reduced merely by minimizing the number of dependencies among cores.

For example, as shown in FIG. 13A, it is supposed that a task set, in which lots of dependency relations exist among tasks which are positioned near the beginning of the task set, is placed onto two cores (cores 0 and 1). In addition, in FIG. 13, A to H each represent a corresponding one of tasks belonging to the task set, and the length of a lateral side of a rectangular box enclosing each of the characters of A to H represents a required execution period of a corresponding one of the tasks. Further, a dashed line having an arrow indicates a dependency relation between tasks, that is, after the completion of execution of a task pointed by the starting point of the dashed line having the arrow, a task pointed by the arrow of the dashed line becomes in an activation ready state. In this case, one of task placement patterns which minimize the number of dependencies between the cores is illustrated in FIG. 13B. However, for example, with respect to a task placement pattern, shown in FIG. 13C, whose number of dependencies between the cores is more than that of the task placement pattern shown in FIG. 13B, an execution period of the entire task set is shorter than that of the task placement pattern shown in FIG. 13B. That is, with respect to the task placement pattern, shown in FIG. 13B, which is obtained by using such a method of minimizing the number of dependencies between the cores, a period from a start of execution of the task set until tasks are concurrently executed by all the cores is longer than that shown in FIG. 13C, and the plurality of cores are not sufficiently utilized at an early stage immediately after the start of execution of the task set.

As described above, there is a case where such a method of minimizing the number of dependencies among cores makes a period during which any task which, actually, can be executed concurrently with other tasks by one of a plurality of cores cannot be placed onto the one of the plurality of cores longer. As a result, there occurs a case where the method of minimizing the number of dependencies among cores cannot sufficiently reduce an amount of core idle time and degrades the performance of execution of a task set.

Further, the aforementioned list scheduling device is capable of performing core allocation and scheduling processing which utilizes a plurality of cores at an early stage immediately after a start of execution. Nevertheless, as described above, such a list scheduling method is effective in a system in which task scheduling on individual cores is statically determined, but is not suitable for a system in which task scheduling on individual cores is dynamically controlled.

The present invention is made in order to solve the aforementioned problem and is intended to provide a task placement device which makes it possible to, for a multi-core system which employs the AMP method and in which task scheduling is dynamically controlled, reduce an amount of core idle time and improve the performance of execution of a targeted system.

### Solution to Problem

A task placement device according to the present invention includes:

a task set parameter acquisition section configured to, for a task set which is a set of a plurality of tasks each being a target fixedly placed onto at least a processor core whose total number is N (N being an integer larger than or equal to one) and which is dynamically controlled while being executed with respect to scheduling of the tasks on the at least a processor core, acquire task-set parameters including at least a subset of pieces of information representing dependency relations among the tasks and a subset of required execution periods each required to complete execution of a corresponding one of the tasks;

a first task placement section configured to detect a scheduling foreseeable period within which the scheduling of the tasks on the at least a processor core after a start of execution of the task set is foreseeable in advance, and with respect to each of at least a first task which is among the tasks included in the task set and which becomes ready for execution within the scheduling foreseeable period, perform task placement processing by determining a core allocation in view of scheduling based on the task-set parameters; and

a second task placement section configured to, with respect to each of at least a second task which is among the tasks included in the task set and which is other than the at least a first task which is subjected to the task placement processing performed by the first task placement section, perform task placement processing by determining a core allocation based on the task-set parameters.

A task placement method according to the present invention includes:

for a task set which is a set of a plurality of tasks each being a target fixedly placed onto at least a processor core whose total number is N (N being an integer larger than or equal to one) and which is dynamically controlled while being executed with respect to scheduling of the tasks on the at least a processor core, acquiring task-set parameters including at least a subset of pieces of information representing dependency relations among the tasks and a subset of required execution periods each required to complete execution of a corresponding one of the tasks;

performing first task placement processing for detecting a scheduling foreseeable period within which the scheduling of the tasks on the at least a processor core after a start of execution of the task set is foreseeable in advance, and determining a core allocation in view of scheduling based on the task-set parameters, with respect to each of at least a first task which is among the tasks included in the task set and which becomes ready for execution within the scheduling foreseeable period; and

performing second task placement processing for determining a core allocation based on the task-set parameters with respect to each of at least a second task which is among the tasks included in the task set and which is other than the at least a first task which is subjected to the first task placement processing.

A computer program that causes a computer to execute processing according to the present invention, includes:

for a task set which is a set of a plurality of tasks each being a target fixedly placed onto at least a processor core whose total number is N (N being an integer larger than or equal to one) and which is dynamically controlled while being executed with respect to scheduling of the tasks on the at least a processor core, acquiring task-set parameters including at least a subset of pieces of information representing dependency relations among the tasks and a subset of required execution periods each required to complete execution of a corresponding one of the tasks;

performing first task placement processing for detecting a scheduling foreseeable period within which the scheduling of the tasks on the at least a processor core after a start of execution of the task set is foreseeable in advance, and determining a core allocation in view of scheduling based on the task-set parameters with respect to each of at least a first task which is among the tasks included in the task set and which becomes ready for execution within the scheduling foreseeable period; and

performing second task placement processing for determining a core allocation based on the task-set parameters with respect to each of at least a second task which is among the tasks included in the task set and which is other than the at least a first task which is subjected to the first task placement processing.

### Advantageous Effects of Invention

The present invention provides a task placement device which makes it possible to, for a multi-core system which employs the AMP method and in which task scheduling is dynamically controlled, reduce an amount of core idle time and improve the performance of execution of a targeted system.

### BRIEF DESCRIPTION OF DRAWINGS

FIG. 1 is a hardware configuration diagram of a task placement device as a first exemplary embodiment of the present invention.

FIG. 2 is a functional block diagram of the task placement device as the first exemplary embodiment of the present invention.

FIG. 3 is a flowchart for describing operation of the task placement device as the first exemplary embodiment of the present invention.

FIG. 4 is a functional block diagram of a task placement device as a second exemplary embodiment of the present invention.

FIG. 5 is a flowchart for describing operation of the task placement device as the second exemplary embodiment of the present invention

FIG. 6 is a schematic diagram illustrating an example of the task set to be placed by the task placement device as the second exemplary embodiment of the present invention.

FIG. 7A is a schematic diagram for describing a specific example of task placement operation which is performed by the task placement device as the second exemplary embodiment of the present invention with respect to a task set shown in FIG. 6.

FIG. 7B is a schematic diagram for describing a specific example of task placement operation which is performed by the task placement device as the second exemplary embodiment of the present invention with respect to the task set shown in FIG. 6.

FIG. 7C is a schematic diagram for describing a specific example of task placement operation which is performed by the task placement device as the second exemplary embodiment of the present invention with respect to the task set shown in FIG. 6.

FIG. 7D is a schematic diagram for describing a specific example of task placement operation which is performed by the task placement device as the second exemplary embodiment of the present invention with respect to the task set shown in FIG. 6.

FIG. 7E is a schematic diagram for describing a specific example of task placement operation which is performed by the task placement device as the second exemplary embodiment of the present invention with respect to the task set shown in FIG. 6.

FIG. 7F is a schematic diagram for describing a specific example of task placement operation which is performed by the task placement device as the second exemplary embodiment of the present invention with respect to the task set shown in FIG. 6.

FIG. 7G is a schematic diagram for describing a specific example of task placement operation which is performed by the task placement device as the second exemplary embodiment of the present invention with respect to the task set shown in FIG. 6.

FIG. 8 is a functional block diagram of a task placement device as a third exemplary embodiment of the present invention.

FIG. 9A is a schematic diagram for describing a specific example of task placement operation which is performed by the task placement device as the third exemplary embodiment of the present invention with respect to the task set shown in FIG. 6.

FIG. 9B is a schematic diagram for describing a specific example of task placement operation which is performed by the task placement device as the third exemplary embodiment of the present invention with respect to the task set shown in FIG. 6.

FIG. 9C is a schematic diagram for describing a specific example of task placement operation which is performed by the task placement device as the third exemplary embodiment of the present invention with respect to the task set shown in FIG. 6.

FIG. 9D is a schematic diagram for describing a specific example of task placement operation which is performed by the task placement device as the third exemplary embodiment of the present invention with respect to the task set shown in FIG. 6.

FIG. 10 is a functional block diagram of a task placement device as a fourth exemplary embodiment of the present invention.

FIG. 11 is a flowchart for describing operation of the task placement device as the fourth exemplary embodiment of the present invention.

FIG. 12A is a schematic diagram for describing a specific example of task placement operation which is performed by the task placement device as the fourth exemplary embodiment of the present invention with respect to the task set shown in FIG. 6.

FIG. 12B is a schematic diagram for describing a specific example of task placement operation which is performed by the task placement device as the fourth exemplary embodiment of the present invention with respect to a task set shown in FIG. 6.

FIG. 12C is a schematic diagram for describing a specific example of task placement operation which is performed by the task placement device as the fourth exemplary embodiment of the present invention with respect to a task set shown in FIG. 6.

FIG. 12D is a schematic diagram for describing a specific example of task placement operation which is performed by the task placement device as the fourth exemplary embodiment of the present invention with respect to a task set shown in FIG. 6.

FIG. 12E is a schematic diagram for describing a specific example of task placement operation which is performed by the task placement device as the fourth exemplary embodiment of the present invention with respect to a task set shown in FIG. 6.

FIG. 12F is a schematic diagram for describing a specific example of task placement operation which is performed by the task placement device as the fourth exemplary embodiment of the present invention with respect to a task set shown in FIG. 6.

FIG. 12G is a schematic diagram for describing a specific example of task placement operation which is performed by the task placement device as the fourth exemplary embodiment of the present invention with respect to a task set shown in FIG. 6.

FIG. 13A is a schematic diagram for describing a task placement pattern obtained by using the related technology.

FIG. 13B is a schematic diagram for describing the task placement pattern obtained by using the related technology.

FIG. 13C is a schematic diagram for describing the task placement pattern obtained by using the related technology.

### DESCRIPTION OF EMBODIMENTS

Hereinafter, exemplary embodiments of the present invention will be described in detail with reference to the drawings. Here, a task placement device as each of exemplary embodiments of the present invention described below is a device which determines a task allocation for a multi-core system employing the AMP method which is a function distribution type method in which each of tasks is executed on one of cores specific thereto. Further, a multi-core system employing the AMP method and being a target of each of exemplary embodiments of the present invention is a system which dynamically performs scheduling for determining, for tasks which are placed on each of cores, when which of the tasks is to be executed. Such scheduling is performed by, for example, an RTOS or the like which operates on each of cores. As described above, in such a multi-core system employing the AMP method, its performance is different depending on which one of cores each of tasks is placed onto. Hereinafter, it will be described that a task allocation device as each of exemplary embodiments of the present invention enables realization of a task allocation which further improves the performance of a multi-core system. In addition, hereinafter, the multi-core system employing the AMP method and being a target of each of exemplary embodiments of the present invention will be also referred to as just a multi-core system.

### First Exemplary Embodiment

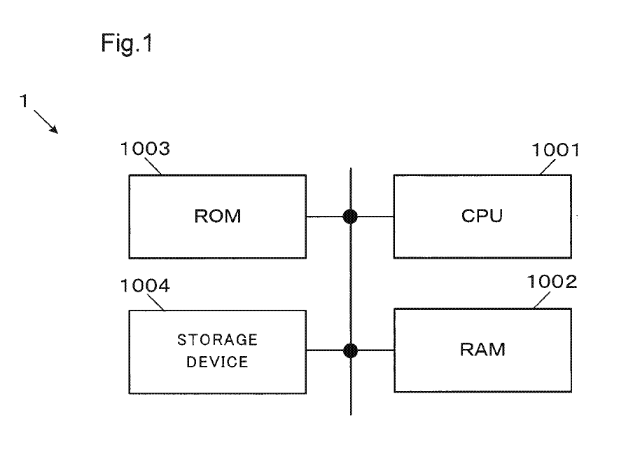

A hardware configuration of a task allocation device 1 as a first exemplary embodiment of the present invention is illustrated in FIG. 1. In FIG. 1, the task allocation device 1 is constituted of a computer device including a central processing unit (CPU) 1001, a random access memory (RAM) 1002, a read only memory (ROM) 1003 and a storage device 1004 such as a hard disk.

The ROM 1003 and the storage device 1004 store therein computer programs and various pieces of data which are for use in causing the computer device to function as the task allocation device 1 of this exemplary embodiment.

The CPU 1001 reads the computer programs and the various pieces of data stored in the ROM 1003 and the storage device 1004 into the RAM 1002, and the CPU 1001 executes the computer programs.

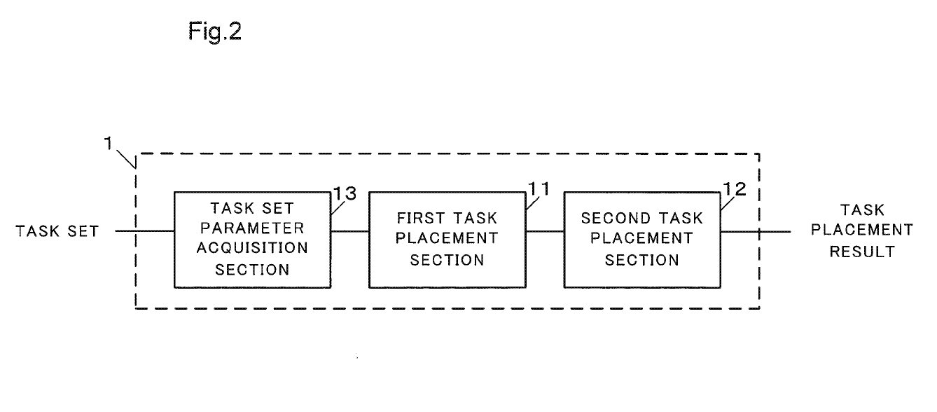

Next, a block diagram of a functional configuration of the task allocation device 1 is illustrated in FIG. 2. In FIG. 2, the task allocation device 1 includes a first task placement section 11, a second task placement section 12 and a task set parameter acquisition section 13. Here, the first task placement section 11, the second task placement section 12 and the task set parameter acquisition section 13 are each allowed to perform its own function by the CPU 1001 which reads the computer programs and the various pieces of data stored in the ROM 1003 and the storage device 1004 into the RAM 1002 and executes the computer programs. In addition, a hardware configuration which allows each of the function blocks of the task allocation device 1 to perform a corresponding function is not limited to the aforementioned configuration.

The task set parameter acquisition section 13 acquires a task-set parameters including at least a subset of pieces of information representing dependency relations among tasks included in a targeted task set and a subset of required execution periods each required in execution of a corresponding one of the tasks included in the targeted task set. The targeted task set is a set of targeted tasks which are fixedly placed onto one or more cores whose number is represented by N (N being an integer larger than or equal to “1”). Further, the targeted task set is a task set which is dynamically controlled while being executed with respect to task scheduling on the individual cores can be dynamically controlled while the task set is executed. For example, the task set parameter acquisition section 13 acquires the task-set parameters retained in the storage device 1004 and may store it into the RAM 1002. The task-set parameters having been acquired by the task set parameter acquisition section 13 are referred to by the first task placement section 11 and the second task placement section 12 which will be described below.

The first task placement section 11 determines core allocations each associated with a corresponding one of tasks which are among tasks included in a task set and which can be executed within a scheduling foreseeable period, while considering scheduling based on task-set parameters associated with the task set. Here, the scheduling foreseeable period is a period which is subsequent to a start of execution of a task set and within which, for each of cores, scheduling of execution of each of tasks be executed thereon can be foreseen beforehand.

Specifically, the first task placement section 11 may sequentially determine a core allocation and scheduling in order from a task which is firstly executable among tasks included in a task set. Further, after a start of placement processing, the first task placement section 11 sequentially determines a core allocation and scheduling with respect to each of tasks to be subsequently executed, as far as a predetermined condition determining the validity of the scheduling foreseeable period is satisfied.

For example, the scheduling foreseeable period may be a period from a start of execution of a task set until a concurrency degree becomes N. Here, it is supposed that the concurrency degree means the number of concurrently executed tasks at a time point during execution of a task set. When the concurrency degree is smaller than or equal to N, dependency relations among tasks are dominant in the determination of execution order of tasks. Thus, in a multi-core system in which task scheduling operations on individual cores are dynamically controlled, on the assumption that any other task than tasks included in a task set targeted by the task allocation device 1 is not concurrently executed, it may be considered that scheduling is uniquely determined provided that the concurrency degree is smaller than or equal to N.

Further, the scheduling foreseeable period may be a period which is subsequent to a start of execution of a task set, and during which a total number of branches in dependency relations remains in a state where it does not exceed N. In this case, the first task placement section 11 may be configured to perform task placement processing while measuring a total number of branches in dependency relations, and terminate the task placement processing at the time when the total number of branches has exceeded N. Alternatively, the first task placement section 11 may be configured to store a total number of tasks beforehand (which is represented by M) until the total number of branches in dependency relations becomes N, and terminate task placement processing at the time when task placement processes on M tasks have been completed.

The second task placement section 12 performs task placement processing by determining a core allocation based on the task-set parameters with respect to each of tasks which are included in a task set and which are other than tasks having been placed by the first task placement section 11.

In addition, the second task placement section 12 may perform the task placement processing by employing a publicly known technology in the determination of a core allocation based on the task-set parameters. Here, when a task group consisting of tasks which are among tasks constituting a task set and which are other than tasks having been placed by the first task placement section 11 is actually executed, scheduled execution clock times of the tasks included in the task group are likely to be changed. Thus, when performing task placement processing on a task, the second task placement section 12 does not necessarily consider scheduling of the task. Accordingly, it is preferable that the second task placement section 12 performs task placement processing on the assumption that, when tasks are actually executed, scheduled execution clock times of the tasks are likely to be changed. For example, it is preferable that the second task placement section 12 performs task placement processing on the basis of an index which is permanently applicable even when scheduled execution clock times of tasks on individual cores are changed when the tasks are actually executed. Specifically, the second task placement section 12 may employ a task placement technology utilizing a method of minimizing the number of dependencies among cores.

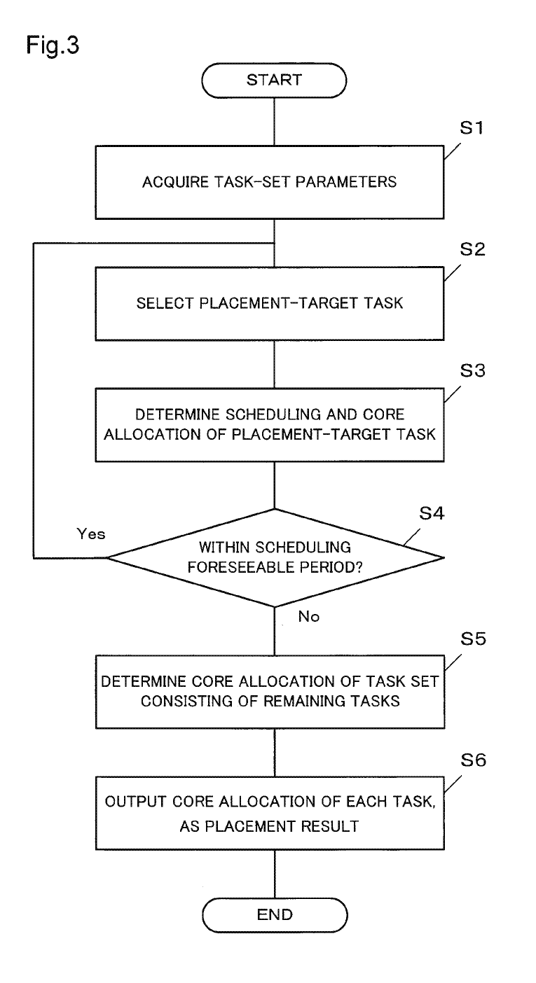

Operation of the task placement device 1 which is configured in such a way as described above will be described with reference to FIG. 3.

First, the task set parameter acquisition section 13 acquires task-set parameters for a task set which is a set of tasks constituting a targeted application (S1).

Next, the first task placement section 11 selects a placement-target task which becomes a placement target, on the basis of the task-set parameters having been acquired in the process of S1 (S2). For example, when this process is carried out for the first time, the first task placement section 11 may select any one of tasks each having no dependency-source task. Further, when this process is carried out for the second and subsequent times, the first task placement section 11 may select any one of tasks each to be released from its dependency waiting state in conjunction with the completion of execution of any one of already placed tasks.

Next, the first task placement section 11 determines a core allocation and scheduling with respect to the placement-target task on the basis of core allocations and scheduled execution clock times with respect to already placed tasks (S3).

Next, the first task placement section 11 determines whether or not a task to be executed next to the placement-target task can be executed within a scheduling foreseeable period (S4). For example, the first task placement section 11 may determine whether or not, as a result of the determination of scheduling of the placement-target task, a concurrency degree during the execution of the placement-target task still remains smaller than N. Alternatively, the first task placement section 11 may determine whether or not a total number of branches in dependency relations among tasks from a task which was placed first up to a task which has been placed this time still remains smaller than N.

Here, in the case where it is determined that the task to be executed next to the placement-target task can be executed within the scheduling foreseeable period, the first task placement section 11 repeats the processes starting from S2.

In contrast, in the case where it is determined that the task to be executed next to the placement-target task cannot be executed within the scheduling foreseeable period, the first task placement section 11 terminates this task placement processing.

Next, the second task placement section 12 determines core allocations with respect to a task group consisting of remaining tasks having not been placed by the first task placement section 11, by referring to the task-set parameters (S5). As described above, for example, the second task placement section 12 may perform task placement processing for minimizing the number of dependencies among cores with respect to the task group consisting of remaining unplaced tasks.

Next, the second task placement section 12 outputs, as a result of the task placement processing, core allocations each associated with a corresponding one of the tasks executable within the scheduling foreseeable period and having been determined by the first task placement section 11, as well as core allocations each associated with a corresponding one of the remaining tasks and having been determined by the second task placement section 12 (S6).

The above is the end of the operation of the task placement device 1.

It is to be noted that the process procedure having been described above is just an example, and the task placement device 1 may perform processing resulting from appropriately interchanging part of the aforementioned processes within a scope not departing from the gist of the present invention. Moreover, the task placement device 1 may appropriately perform concurrent processing with respect to part of the aforementioned processes within a scope not departing from the gist of the present invention.

Next, advantageous effects of this first exemplary embodiment of the present invention will be described.

The task placement device as this first exemplary embodiment of the present invention makes it possible to, for a multi-core system which employs the AMP method and in which task scheduling is dynamically controlled, reduce an amount of core idle time and improve the performance of a targeted system.

A reason for this is because, with respect to each of tasks constituting a task group which can be executed within a scheduling foreseeable period during which task execution scheduling is foreseeable, the first task placement section performs task placement processing for determining a core allocation in view of scheduling of the task; while, with respect to each of tasks constituting a task group consisting of remaining unplaced tasks, the second task placement section determines a core allocation of the task.

Through this method, the task placement device as this exemplary embodiment makes it possible to, for a multi-core system constituted of N cores, provide a task placement pattern which allows N tasks to be concurrently executed such that each of the N tasks is executed by a corresponding one of the N tasks at as an early stage as possible immediately after a start of execution. Moreover, with respect to a task group consisting of remaining unplaced tasks for each of which execution schedule is not foreseeable, the task placement device as this exemplary embodiment makes it possible to apply a task placement technology which brings about a favorable execution result on the assumption that, when tasks on individual cores are actually executed, scheduled execution clock times of the tasks are likely to be changed. Thus, the task placement device as this exemplary embodiment makes it possible to perform task placement processing which sufficiently utilizes a plurality of cores at an early stage immediately after a start of execution. As a result, the task placement device as this exemplary embodiment makes it possible to reduce an amount of core idle time, and output a task placement pattern which improves the performance of a targeted system.

### Second Exemplary Embodiment

Next, a second exemplary embodiment of the present invention will be described in detail with reference to some of the drawings. In addition, in each of drawings referred to in description of this exemplary embodiment, the same constituent component as that of the first exemplary embodiment and a process operating in the same manner as that of the process of the first exemplary embodiment are each denoted by the same sign as that of the first exemplary embodiment, and detailed description thereof will be omitted in this exemplary embodiment.

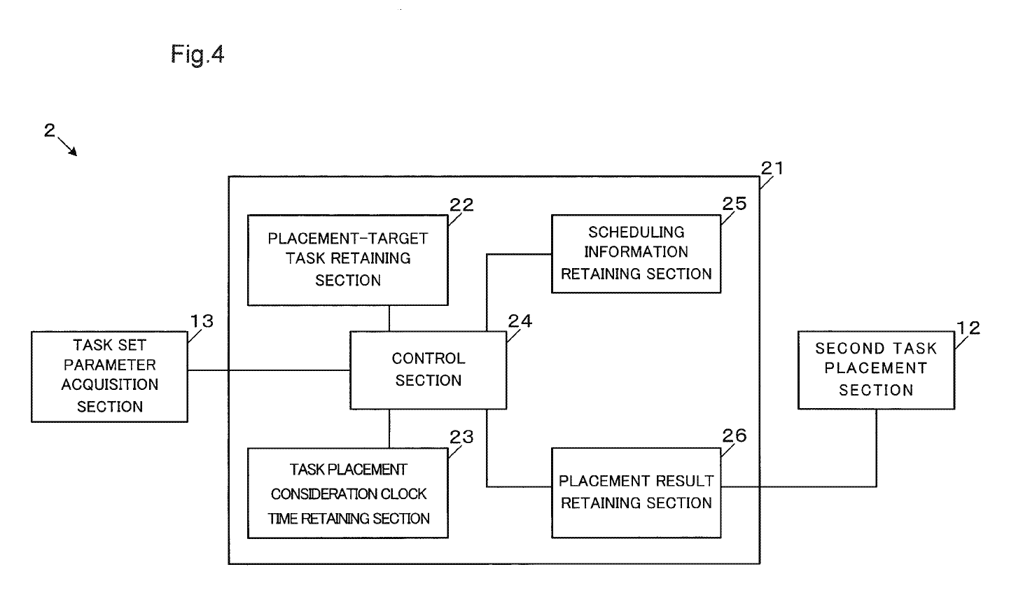

A block diagram of a functional configuration of a task placement device 2 as this second exemplary embodiment of the present invention is illustrated in FIG. 4. In FIG. 4, the task placement device 2 is different from the task placement device 1 as the first exemplary embodiment of the present invention in the respect that the task placement device 2 includes a first task placement section 21 in substitution for the first task placement section 11. Further, the first task placement section 21 includes a placement-target task retaining section 22, a task placement consideration clock time retaining section 23, a control section 24, a scheduling information retaining section 25 and a placement result retaining section 26.

The placement-target task retaining section 22 retains a piece of information representing a placement-target task which is a task to be made a placement target next. A placement-target task represented by the piece of information retained by the placement-target task retaining section 22 is updated by the control section 24 described below.

The task placement consideration clock time retaining section 23 retains a clock time at which placement of a placement-target task becomes ready for execution, as a task placement consideration clock time which is represented by making a task set execution start clock time a reference clock time. Here, the task set execution start clock time is a clock time at which execution of a relevant task set can be started. The task set execution start clock time may be represented by “0”. The task placement consideration clock time retained by the task placement consideration clock time retaining section 23 is updated by the control section 24 described below on the basis of scheduled execution clock times of individual tasks having been already placed.

The control section 24 performs a core allocation in view of scheduling with respect to each of tasks which can be executed within a scheduling foreseeable period, that is, within a period from a task set execution start clock time until a concurrency degree becomes N. Specifically, the control section 24 determines a core allocation as well as a piece of scheduling information including an execution start clock time and an execution end clock time with respect a placement-target task on the basis of a task placement consideration clock time associated with the placement-target task as well as the task-set parameters. Further, on the basis of the core allocation and the piece of scheduling information which have been determined with respect to the placement-target task, the control section 24 updates the placement-target task retained by the placement-target task retaining section 22 as well as the task placement consideration clock time retained by the task placement consideration clock time retaining section 23.

The scheduling information retaining section 25 retains a piece of scheduling information (an execution start clock time and an execution end clock time) with respect to each of tasks for which task placement operations have been performed.

The placement result retaining section 26 retains a placement result which is a core allocation having been determined with respect to each of tasks for which task placement operations have been performed.

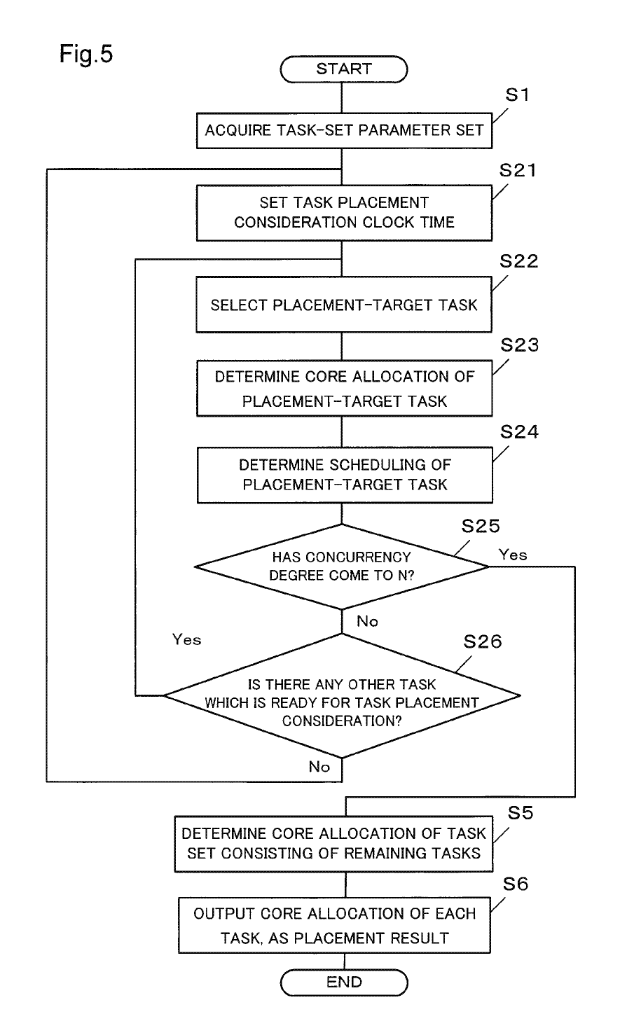

Operation of the task placement device 2 which is configured in such a way as described above will be described with reference to FIG. 5.

First, the task set parameter acquisition section 13 acquires task-set parameters for a task set which is a set of tasks constituting a targeted application (S1).

Next, the control section 24 sets a task placement consideration clock time and causes the task placement consideration clock time retaining section 23 to retain it (S21).

For example, when this process is carried out for the first time, the control section 24 may set a task set execution start clock time as the task placement consideration clock time. Further, when this process is carried out for the second and subsequent times, the control section 24 may set, as the task placement consideration clock time, the earliest one of clock times at each of which at least one of tasks which become ready for execution next appears. For example, through reference to the scheduling information retaining section 25, the control section 24 may set, as the task placement consideration clock time, an execution end clock time of any one of at least a task which is among tasks having been already subjected to core allocation and scheduling processing and which, in a period after a current task placement consideration clock time, completes its execution at the earliest one of clock times at each of which at least one of the tasks having been already subjected to core allocation and scheduling processing completes its task.

Next, the control section 24 selects, as a placement-target task, any one of tasks each of which is ready for a task placement consideration at the task placement consideration clock time having been set in the process of S21. Further, the control section 24 causes the placement-target task retaining section 22 to retain a piece of information indicating the selected placement-target task (S22).

For example, when this process is carried out for the first time, the control section 24 selects a first one of tasks included in a task set as a placement-target task. Here, this first task may be a task which has no dependency-source task in the task set. Further, when this process is carried out for the second and subsequent times, the control section 24 selects, as a placement-target task, a task which is released from a dependency waiting state and becomes in the execution ready state in conjunction with the completion of execution of any one of tasks having been already placed. In addition, in the case where there is a plurality of tasks each of which is ready for a task placement consideration at the task placement consideration clock time, the control section 24 may select, as a placement-target task, any one of the plurality of tasks.

Next, the control section 24 determines a core allocation of the placement-target task having been selected in the process of S22 (S23). For example, at the task placement consideration clock time, the control section 24 may place the placement-target task onto a core having the smallest one of core serial numbers of cores on each of which any task is not placed.

Next, the control section 24 determines a piece of scheduling information with respect to the placement-target task having been selected in the process of S22, and causes the scheduling information retaining section 25 to retain it (S24). Specifically, the control section 24 determines an execution start clock time and an execution end clock time of the placement-target task.

For example, in the case where a dependency-source task of the placement-target task is already placed on the same core as a core having been derived from the core allocation relating to the placement-target task and having been determined in the process of S23, the control section 24 can determine the task placement consideration clock time as the execution start clock time of the placement-target task. In most cases, the execution start clock time of the placement-target task, such as is determined in this way, becomes an execution end clock time of the dependency-source task. This is because the placement-target task is released from a dependency waiting state and becomes in the execution ready state in conjunction with the completion of execution of the dependency-source task.

Further, for example, let us consider a case where a dependency-source task of the placement-target task is placed on a core different from a core having been derived from the core allocation relating to the placement-target task and having been determined in the process of S23. In this case, when communication overhead between cores is regarded as “0”, the control section 24 can determine the task placement consideration clock time as the execution start clock time of the placement-target task just like the case where a dependency-source task of the placement-target task is placed on the same core as a core having been derived from the core allocation of the placement-target task. Alternatively, the control section 24 may determine the execution start clock time of the placement-target task by adding communication overhead between cores to the task placement consideration clock time.

Further, for example, the control section 24 may determine, as the execution end clock time of the placement-target task, a clock time resulting from adding a required execution period to the execution start clock time.

Next, the control section 24 determines whether or not a concurrency degree has become N (S25). That is, the control section 24 determines whether or not there remains a core which is not executing any task during a period of execution of the placement-target task having been placed this time. Through this process, the control section 24 determines whether or not a next placement-target task can be carried out within a scheduling foreseeable period.

In the case where, in the process of S25, it is determined that the concurrency degree has not yet come to N, the control section 24 determines whether or not there is any other task which is ready for a task placement consideration at a current task placement consideration clock time (S26).

In the case where, in the process of S26, it is determined that there is another task which is ready for a task placement consideration at this task placement consideration clock time, the control section 24 does not update the task placement consideration clock time, and repeats the processes from the process of S22 in which the placement-target task is updated.

In contrast, in the case where, in the process of S26, it is determined that there is not any other task which is ready for a task placement consideration at this task placement consideration clock time, the control section 24 repeats the processes from the process of S21 in which the task placement consideration clock time is updated.

In contrast, in the case where, in the process of S25, it is determined that that the concurrency degree has become N, the control section 24 terminates the task placement processing performed by the first task placement section 21. Further, the second task acquisition section 12 performs task placement processing with respect to a task group consisting of remaining tasks having not been placed by the first task placement section 21, and outputs core allocations of individual tasks included in a task set, just like the processes of S5 to S6 in the first exemplary embodiment of the present invention.

The above is the end of the operation of the task placement device 2.

It is to be noted that the process procedure having been described above is just an example, and the task placement device 2 may perform processing resulting from appropriately interchanging part of the aforementioned processes within a scope not departing from the gist of the present invention. Moreover, the task placement device 2 may appropriately perform concurrent processing with respect to part of the aforementioned processes within a scope not departing from the gist of the present invention.

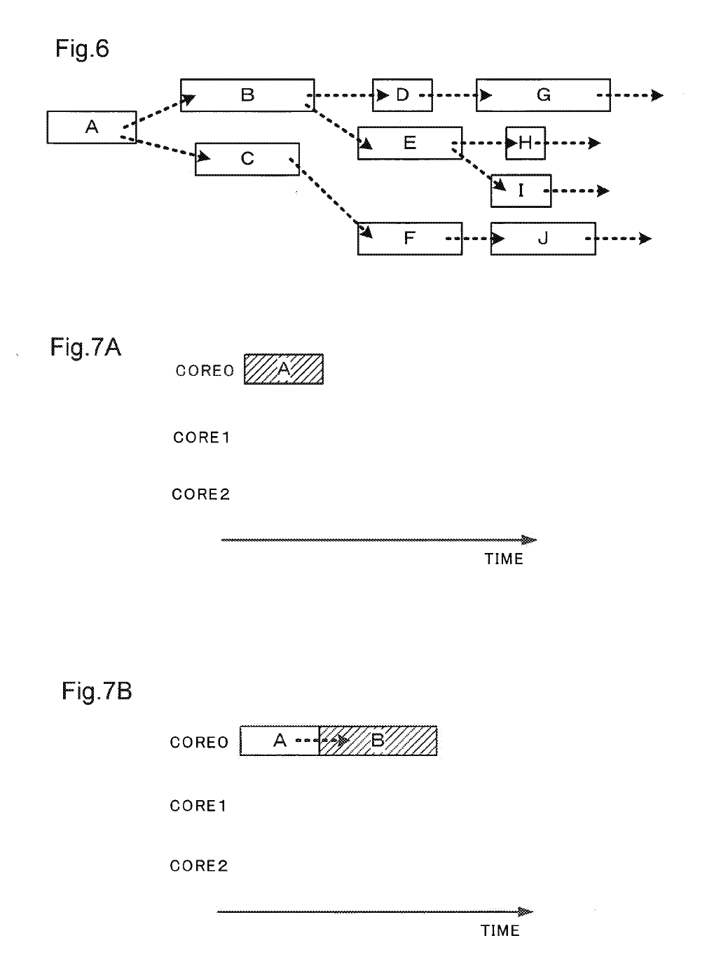

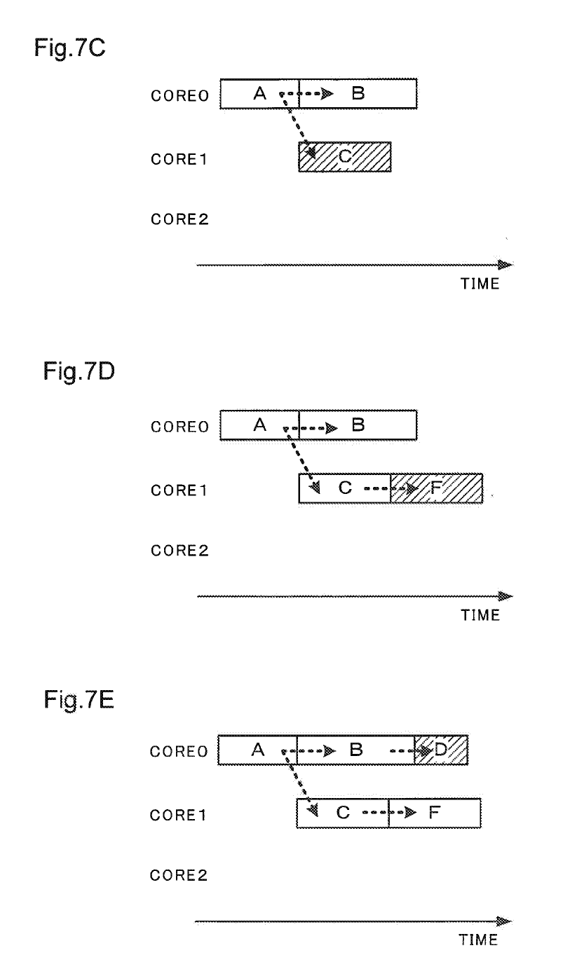

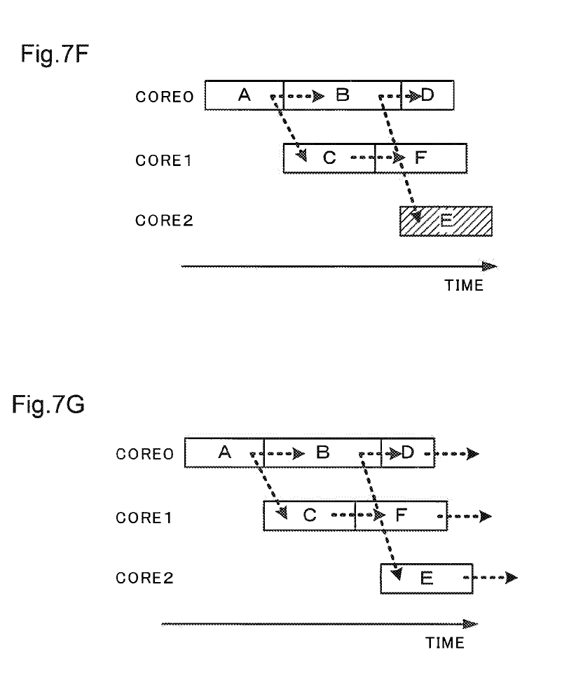

Next, a specific example of the operation of the task placement device 2 will be described with reference to FIGS. 6 and 7. This description will be made on the assumption that a task set including tasks A to J is placed onto three cores to each of which a corresponding one of core serial numbers (cores 0 to 2) is allocated. In FIGS. 6 and 7, A to J each represent a corresponding one of tasks belonging to the task set, and the length of a lateral side of a rectangular box enclosing each of the characters of A to J represents a required execution period of a corresponding one of the tasks. Further, a dashed line having an arrow indicates a dependency relation between tasks, that is, after the completion of execution of a task pointed by the starting point of the dashed line having the arrow, a task pointed by the arrow of the dashed line becomes in an activation ready state. In addition, in description of this specific example, it is assumed that the task placement device 2 can place a placement-target task onto one of a plurality of cores and in the case where there is no influence whichever of the cores a core allocation of the placement-target task is made onto, the core allocation of the placement-target task is made onto a core having a core serial number smaller than those of any other cores. Further, it is assumed that, in the case where there is a plurality of tasks each of which is in the execution ready state at a task placement consideration clock time and there is no influence whichever of the tasks is subjected to task placement processing first, each of the tasks is sequentially selected as a placement-target task in alphabetical order.

FIG. 6 illustrates dependency relations among the tasks A to J included in the task set. For example, each of the tasks B and C has a dependency relation with the task A. There are also dependency relations each represented by a dashed line having an arrow among other tasks. In addition, subsequent tasks each having a dependency relation with a corresponding one of the tasks G, H, I and J are omitted from illustration.

Next, operation of the task placement device 2 with respect to the task set shown in FIG. 6 will be described with reference to FIGS. 7A to 7G.

<Placement Processing for Task A>

First, placement processing for task A will be described with reference to FIG. 7A.

Here, first, the control section 24 sets a new current task placement consideration clock time to “0” which is a task set execution start clock time (S21).

Further, the control section 24 selects, as a placement-target task, the task A which is ready for execution at this current task placement consideration clock time “0” (S22).

Next, the control section 24 allocates the core 0, which has the smallest one of the core serial numbers of the cores 0 to 2 which can be allocated the task A, to the task A (S23).

Next, the control section 24 sets, as an execution start clock time of the task A, the current task placement consideration clock time “0”. Further, the control section 24 sets, as an execution end clock time of the task A, a clock time resulting from adding a required execution period of the task A to the execution start clock time of the task A (S24).

Next, the control section 24 determines that a concurrency degree is “1” and has not yet come to N which is equal to “3” (No in S25).

Next, the control section 24 determines that there is not any other task which is in the execution ready state at the current task placement consideration clock time “0” (No in S26).

<Placement Processing for Task B>

Next, placement processing for task B will be described with reference to FIG. 7B.

Here, first, the control section 24 sets a new current task placement consideration clock time to the execution end clock time of the task A (S21).

Next, the control section 24 selects, as a placement-target task, the task B which is one of the tasks B and C which become ready for execution at this current task placement consideration clock time and which is anterior to the task C in the alphabetical order (S22).

Next, the control section 24 allocates the core 0, which has the smallest one of the core serial numbers of the cores 0 to 2 which can be allocated the task B, to the task B (S23).

Next, the control section 24 sets, as an execution start clock time of the task B, the execution end clock time of the task A which is the current task placement consideration clock time. Further, the control section 24 sets, as an execution end clock time of the task B, a clock time resulting from adding a required execution period of the task B to the execution start clock time of the task B (S24).

Next, the control section 24 determines that the concurrency degree is “1” and has not yet come to N which is equal to “3” (No in S25).

Next, the control section 24 determines that there exists the task C as another task which is ready for execution at the current task placement consideration clock time (Yes in S26).

<Placement Processing for Task C>

Next, placement processing for the task C will be described with reference to FIG. 7C. In addition, the current task placement consideration clock time still remains set to the execution end clock time of the task A.

Here, first, the control section 24 selects, as a placement-target task, the task C which becomes ready for execution at the current task placement consideration clock time (S22).

Next, since the task B is already placed on the core 0, the control section 24 allocates the core 1, which has a smaller one of the core serial numbers of the cores 1 and 2 which can be allocated the task C, to the task C (S23).

Next, the control section 24 sets, as an execution start clock time of the task C, the execution end clock time of the task A which is the current task placement consideration clock time. Further, the control section 24 sets, as an execution end clock time of the task C, a clock time resulting from adding a required execution period of the task C to the execution start clock time of the task C (S24).

Next, the control section 24 determines that the concurrency degree is “2” and has not yet come to N which is equal to “3” (No in S25).

Next, the control section 24 determines that there is not any other task which is ready for execution at the current task placement consideration clock time (No in S26).

<Placement Processing for Task F>

Next, placement processing for task F will be described with reference to FIG. 7D.

Here, first, the control section 24 determines that the earliest one of clock times at each of which at least one of tasks which become ready for execution next appears is the execution end clock time of the task C. Thus, the control section 24 sets a new current task placement consideration clock time to the execution end clock time of the task C (S21).

Next, the control section 24 selects the task F as a placement-target task. The task F becomes ready for execution at this current task placement consideration clock time (S22).

Next, the control section 24 determines that, on the core 0, the execution of the task B having been placed is not yet completed at the current task placement consideration clock time. Thus, the control section 24 allocates the core 1, which has a smaller one of the core serial numbers of the cores 1 and 2 which can be allocated the task F, to the task F (S23).

Next, the control section 24 sets, as an execution start clock time of the task F, the execution end clock time of the task C which is the current task placement consideration clock time. Further, the control section 24 sets, as an execution end clock time of the task F, a clock time resulting from adding a required execution period of the task F to the execution start clock time of the task F (S24).

Next, the control section 24 determines that the concurrency degree is “2” and has not yet come to N which is equal to “3” (No in S25).

Next, the control section 24 determines that there is not any other task which is ready for execution at the current task placement consideration clock time (No in S26).

<Placement Processing for Task D>

Next, placement processing for task D will be described with reference to FIG. 7E.

Here, first, the control section 24 determines that the earliest one of clock times at each which at least one of tasks which become ready for execution next appears is the execution end clock time of the task B. Thus, the control section 24 sets a new current task placement consideration clock time to the execution end clock time of the task B (S21).

Next, the control section 24 selects, as a placement-target task, the task D which is one of the tasks D and E which become ready for execution at this current task placement consideration clock time and which is anterior to the task E in the alphabetical order (S22).

Next, the control section 24 determines that, on the core 1, the execution of the task F having been placed is not yet completed at the current task placement consideration clock time. Thus, the control section 24 allocates the core 0, which has a smaller one of the core serial numbers of the cores 0 and 2 which can be allocated the task D, to the task D (S23).

Next, the control section 24 sets, as an execution start clock time of the task D, the execution end clock time of the task B which is the current task placement consideration clock time. Further, the control section 24 sets, as an execution end clock time of the task D, a clock time resulting from adding a required execution period of the task D to the execution start clock time of the task D (S24).

Next, the control section 24 determines that the concurrency degree is “2” and has not yet come to N which is equal to “3” (No in S25).

Next, the control section 24 determines that there exists the task E as another task which is ready for execution at the current task placement consideration clock time (Yes in S26).

<Placement Processing for Task E>

Next, placement processing for the task E will be described with reference to FIG. 7F. In addition, the current task placement consideration clock time still remains set to the execution end clock time of the task B.

Here, first, the control section 24 selects, as a placement-target task, the task E which becomes ready for execution at the current task placement consideration clock time (S22).

Next, the control section 24 determines that the task D is already placed on the core 0. Further, the control section 24 determines that, on the core 1, the execution of the task F having been placed is not completed at the current task placement consideration clock time. Thus, the control section 24 allocates the core 2 to the task E (S23).

Next, the control section 24 sets, as an execution start clock time of the task E, the execution end clock time of the task B which is the current task placement consideration clock time. Further, the control section 24 sets a clock time as an execution end clock time of the task E. The clock time results from adding a required execution period of the task E to the execution start clock time of the task E (S24).

Next, the control section 24 determines that the concurrency degree becomes “3” and has come to N equal to “3” (Yes in S25). That is, since the placement has resulted in a state where three tasks are concurrently executed such that each of the tree tasks is executed on a corresponding one of the three cores, the first task placement section 21 terminates the placement processing. Through these processes described above, a task placement pattern which utilizes three cores at an early stage immediately after a start of execution can be obtained as shown in FIG. 7G.

In subsequent processes, the second task acquisition section 12 performs task placement processing by determining core allocations with respect to a task group consisting of remaining unplaced tasks including the tasks G, H, I and J shown in FIG. 6. As described above, the second task acquisition section 12 can use a placement method which does not necessarily need any scheduling determination.

In addition, in this specific example, the description has been made on the assumption that there is no difference in an execution start clock time between a case where two tasks which have dependency relations with each other are each placed onto a corresponding one of different cores and a case where the two tasks are placed onto the same core. In the case where overhead of communication between cores is taken into consideration, the first task placement section 21 may set, as an execution start clock time of a placement-target task, a clock time resulting from adding the overhead of communication between cores to a current task placement consideration clock time.

Next, advantageous effects of the second exemplary embodiment of the present invention will be described.

The task placement device as this second exemplary embodiment of the present invention makes it possible to, for a multi-core system which employs the AMP method and in which task scheduling is dynamically controlled, reduce an amount of core idle time and improve the performance of a targeted system.

A reason for this is because, with respect to each of tasks constituting a task group which can be executed within a scheduling foreseeable period which is a period from an execution start clock time of the task set until the concurrency degree has come to N, the first task placement section performs task placement processing in which a core allocation and scheduling are determined in view of scheduling of tasks having been already placed; while, with respect to each of tasks constituting a task group consisting of remaining unplaced tasks, the second task placement section determines a core allocation of the task.

Through this method, the task placement device as this exemplary embodiment makes it possible to, within a scheduling foreseeable period from an execution start clock time of a task set until the concurrency degree has come to N, perform task placement processing such that, in the case where a placement-target task can be executed concurrently with one or more tasks having been already placed, a core is allocated to the placement-target task so as to allow the placement-target task to be executed concurrently with the one or more tasks as far as possible. In this way, the task placement device as this exemplary embodiment sequentially determines an appropriate core allocation with respect to each of placement-target tasks on the basis of scheduling of each of tasks having been placed so far. Through this method, the task placement device as this exemplary embodiment makes it possible to, for a multi-core system constituted of N cores, provide a task placement pattern which reduces a period from a start clock time of a task set until N tasks are concurrently executed such that each of the N tasks is executed by a corresponding one of N cores as far as possible. Thus, as a result, the task placement device as this exemplary embodiment makes it possible to, for a multi-core system employing the AMP method, reduce an amount of core idle time and improve the performance of a targeted system by performing task placement processing which utilizes a plurality of cores at an early stage immediately after a start of execution.

### Third Exemplary Embodiment

Next, a third exemplary embodiment of the present invention will be described in detail with reference to some of the drawings. In addition, in each of drawings referred to in description of this exemplary embodiment, the same constituent component as that of the second exemplary embodiment and a process operating in the same manner as that of the process of the second exemplary embodiment are each denoted by the same sign as that of the second exemplary embodiment, and detailed description thereof will be omitted in this exemplary embodiment.

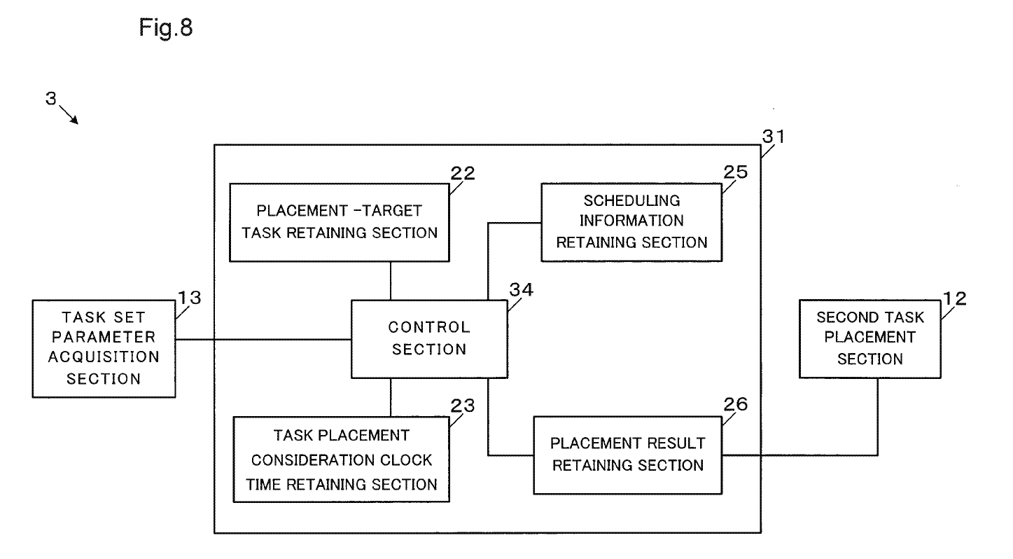

First, a block diagram of a functional configuration of a task placement device 3 as this third exemplary embodiment of the present invention is illustrated in FIG. 8. In FIG. 8, the task placement device 3 is different from the task placement device 2 as the second exemplary embodiment of the present invention in the respect that the task placement device 3 includes a first task placement section 31 in substitution for the first task placement section 21. Further, the first task placement section 31 is different from the first task placement section 21 in the second exemplary embodiment of the present invention in the respect that the first task placement section 31 includes a control section 34 in substitution for the control section 24.

The control section 34 is different from the control section 24 in the second exemplary embodiment of the present invention in the respect that a period from an execution start clock time of a task set until the concurrency degree comes to (N+1) is made a scheduling foreseeable period. The control section 34 is configured, in respects other than this, in the same way as that of the control section 24 in the second exemplary embodiment of the present invention.

The task placement device 3 configured in such a way as described above operates in substantially the same way as that of the task placement device 2 as the second exemplary embodiment of the present invention shown, shown in FIG. 5, but the task placement device 3 is different from the task placement device 2 in the operation of the process of S25.

In the process of S25, the control section 34 determines whether or not the concurrency degree has come to (N+1).

The above is the end of the operation of the task placement device 3.

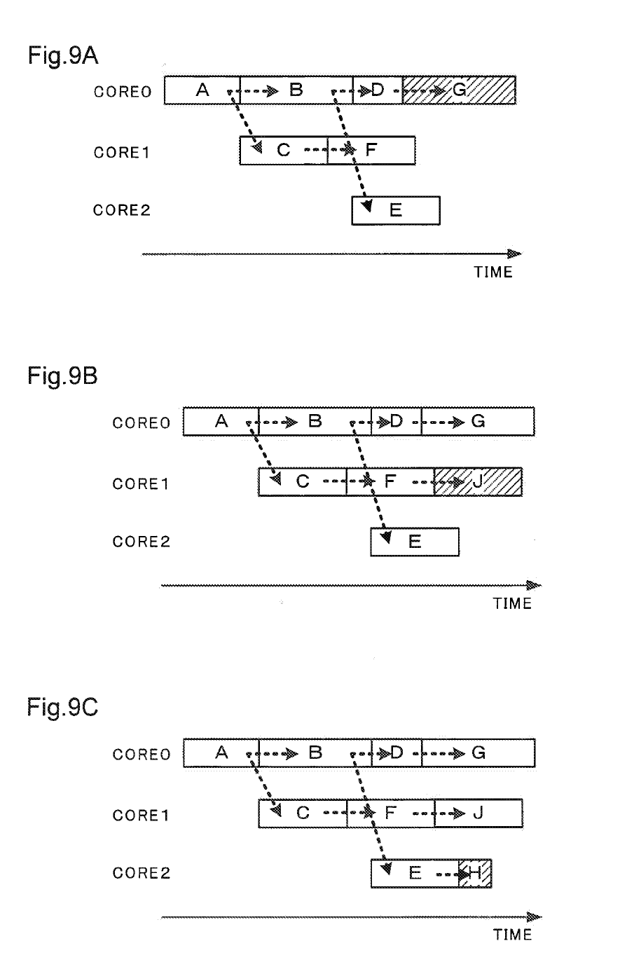

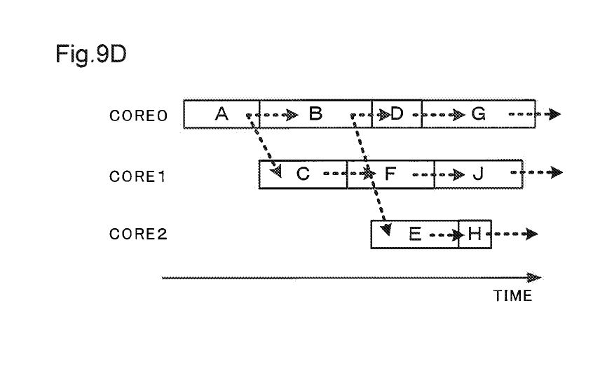

Next, a specific example of the operation of the task placement device 3 will be described with reference to FIG. 9. Here, the specific example of the operation of the task placement device 3 will be described by using the task set, shown in FIG. 6, having been used in the description of the specific example of the operation of the task placement device 2 as the second exemplary embodiment of the present invention.

First, in FIG. 7A to FIG. 7F, the task placement device 3 performs task placement processing in the same way as that of the task placement device 2 as the second exemplary embodiment of the present invention. In this regard, however, in the process of S25 of the process flow in which the task E is made a placement-target task, the control section 34 determines that the concurrency degree is “3” and has not yet come to (N+1) which is equal to “4” (No in S25). As a result, as shown in FIG. 7G, the first task placement section 31 continues the task placement processing under the state where the tasks A to F have been placed.

<Placement Processing for Task G>

First, placement processing for the task G will be described with reference to FIG. 9A.

Here, first, the control section 34 determines that the earliest one of time clocks at each of which at least one of tasks which become ready for execution next appears is the execution end clock time of the task D. Thus, the control section 34 sets a new current task placement consideration clock time to the execution end clock time of the task D (S21).

Next, the control section 34 selects the task G as a placement-target task. The task G becomes ready for execution at this current task placement consideration clock time (S22).

Next, the control section 34 determines that, on the cores 1 and 2, the execution of each of other tasks is not yet completed at the current task placement consideration clock time. Thus, the control section 34 allocates the core 0 to the task G (S23).

Next, the control section 24 sets, as an execution start clock time of the task G, the execution end clock time of the task D which is the current task placement consideration clock time. Further, the control section 24 sets, as an execution end clock time of the task G, a clock time resulting from adding a required execution period of the task G to the execution start clock time of the task G (S24).

Next, the control section 34 determines that the concurrency degree is “3” and has not yet come to (N+1) which is equal to “4” (No in S25).

Next, the control section 34 determines that there is not any other task which is ready for execution at the current task placement consideration clock time (No in S26).

<Placement Processing for Task J>

Next, placement processing for the task J will be described with reference to FIG. 9B.

Here, first, the control section 34 determines that the earliest one of time clocks at each of which at least one of tasks which become ready for execution next appears is the execution end clock time of the task F. Thus, the control section 34 sets a new current task placement consideration clock time to the execution end clock time of the task F (S21).

Next, the control section 34 selects the task J as a placement-target task. The task J becomes ready for execution at the current task placement consideration clock time (S22).

Next, the control section 34 determines that, on the cores 0 and 2, the execution of each of other tasks is not yet completed at the current task placement consideration clock time. Thus, the control section 34 allocates the core 1 to the task J (S23).

Next, the control section 34 sets, as an execution start clock time of the task J, the execution end clock time of the task F which is the current task placement consideration clock time. Further, the control section 24 sets, as an execution end clock time of the task J, a clock time resulting from adding a required execution period of the task J to the execution start clock time of the task J (S24).

Next, the control section 34 determines that the concurrency degree is “3” and has not yet come to (N+1) which is equal to “4” (No in S25).

Next, the control section 34 determines that there is not any other task which is ready for execution at the current task placement consideration clock time (No in S26).

<Placement Processing for Task H>

Next, placement processing for the task H will be described with reference to FIG. 9C.

Here, first, the control section 34 determines that the earliest one of time clocks at each of which at least one of tasks which become ready for execution next appears is the execution end clock time of the task E. Thus, the control section 34 sets a new current task placement consideration clock time to the execution end clock time of the task E (S21).

Next, the control section 34 selects the task H as a placement-target task. The task H which is one of the tasks H and I which become ready for execution at this current task placement consideration clock time and which is anterior to the task I in the alphabetical order. (S22).

Next, the control section 34 determines that, on the cores 0 and 1, the execution of each of other tasks is not yet completed at the current task placement consideration clock time. Thus, the control section 34 allocates the core 2 to the task H (S23).

Next, the control section 34 sets, as an execution start clock time of the task H, the execution end clock time of the task E which is the current task placement consideration clock time. Further, the control section 34 sets, as an execution end clock time of the task H, a clock time resulting from adding a required execution period of the task H to the execution start clock time of the task H (S24).

Next, the control section 34 determines that, besides the tasks G, J and H having been placed onto the cores 0 and 1, there exists the task I which can be executed concurrently therewith, and calculates that the concurrency degree is “4”. Thus, the control section 34 determines that the concurrency degree has come equal to (N+1) (Yes in S25). That is, the task placement has resulted in a state where, although four tasks can be concurrently executed, each of three ones of the tasks is already executed on a corresponding one of three cores, and thus, a remaining one of the tasks cannot be executed. Thus, the first task placement section 31 terminates the task placement processing. Through these processes, a task placement pattern, which utilizes three cores at an early stage immediately after a start of execution, can be obtained as shown in FIG. 9D.

In subsequent processes, the second task acquisition section 12 performs task placement processing by determining core allocations with respect to a task group consisting of remaining unplaced tasks including the task I, shown in FIG. 6. As described above, the second task acquisition section 12 can use a placement method which does not necessarily need any scheduling determination.

In addition, in this specific example, the description has been made on the assumption that there is no difference in an execution start clock time between a case where two tasks which have dependency relations with each other are each placed onto a corresponding one of different cores and a case where the two tasks are placed onto the same core. In the case where overhead of communication between cores is taken into consideration, the first task placement section 31 may set, as an execution start clock time of a placement-target task, a clock time resulting from adding the overhead of communication between cores to a current task placement consideration clock time.

Further, in this exemplary embodiment, the first task placement section 31 performs the process (S25) of determining whether or not the concurrency degree has come to (N+1) after having performed the task placement processing (processes of S23 to S24). As a configuration different from this, the first task placement section 31 may perform the process (S25) of determining whether or not the concurrency degree has come to (N+1) before performing the task placement processing (processes of S23 to S24). In this case, as a result, in the operation of the specific example having been described using FIG. 9, the first task placement section 31 terminates the task placement processing in the state shown in FIG. 9B before the placement processing for the task H. In this case, the second task acquisition section 12 may perform task placement processing merely by determining core allocations with respect to a task group consisting of remaining unplaced tasks including the tasks H and I.

Next, advantageous effects of this third exemplary embodiment of the present invention will be described.

The task placement device as this third exemplary embodiment of the present invention makes it possible to, for a multi-core system which employs the AMP method and in which task scheduling is dynamically controlled, reduce an amount of core idle time and improve the performance of a targeted system.

A reason for this is because, with respect to each of tasks constituting a task group consisting of tasks which become ready for execution within a scheduling foreseeable period which is a period from an execution start clock time of the task set until the concurrency degree has come to (N+1), the first task placement section performs task placement processing in which a core allocation and scheduling are determined in view of scheduling of tasks having been already placed. Further, with respect to each of tasks constituting a task group consisting of remaining unplaced tasks, the second task placement section determines a core allocation without needing to consider scheduling.

Through this method, the task placement device as this exemplary embodiment makes it possible to, within a scheduling foreseeable period from an execution start clock time of a task set until the concurrency degree has come to (N+1), perform task placement processing such that, in the case where a placement-target task can be executed concurrently with one or more tasks having been already placed, a core is allocated to the placement-target task so as to allow the placement-target task to be executed concurrently with the one or more tasks as far as possible. In this way, the task placement device as this exemplary embodiment makes it possible to, for a multi-core system constituted of N cores, provide a task placement pattern which reduces a period from a start clock time of a task set until N tasks are concurrently executed such that each of the N cores is executed by a corresponding one of N cores as far as possible by sequentially determining an appropriate core allocation with respect to each of placement-target tasks on the basis of scheduling of each of tasks having been placed so far. Thus, as a result, the task placement device as this exemplary embodiment makes it possible to, for a multi-core system employing the AMP method, reduce an amount of core idle time and improve the performance of a targeted system by performing task placement processing which utilize a plurality of cores at an early stage immediately after a start of execution.

### Fourth Exemplary Embodiment

Next, a fourth exemplary embodiment of the present invention will be described in detail with reference to some of the drawings. In addition, in each of drawings referred to in description of this exemplary embodiment, the same constituent component as that of the second exemplary embodiment and a process operating in the same manner as that of the process of the second exemplary embodiment are each denoted by the same sign as that of the second exemplary embodiment, and detailed description thereof will be omitted in this exemplary embodiment.

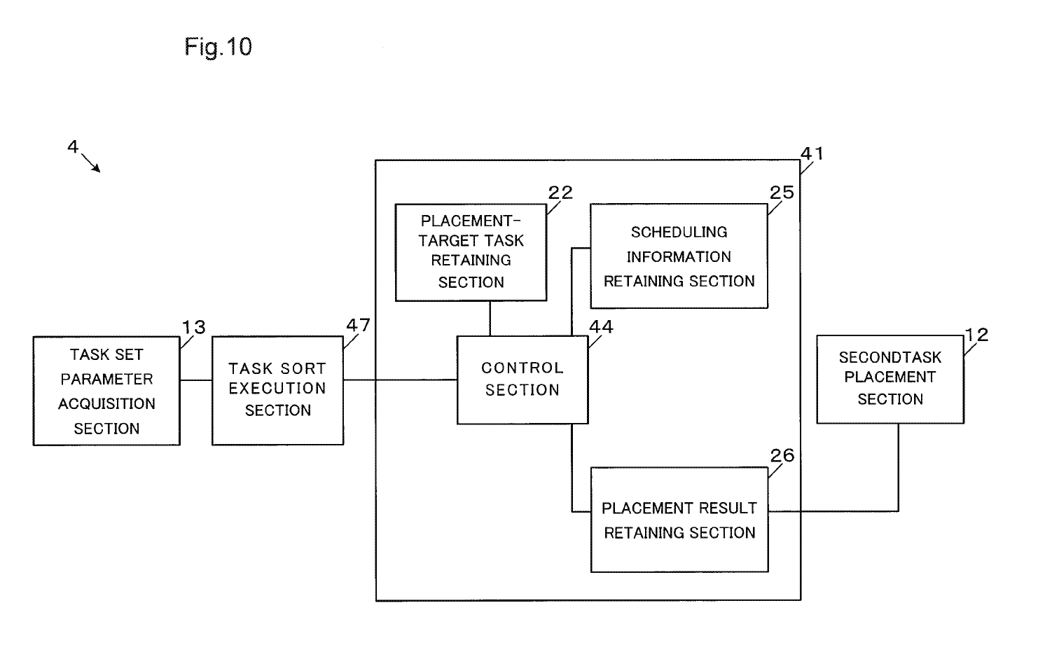

First, a block diagram of a functional configuration of a task placement device 4 as this fourth exemplary embodiment of the present invention is illustrated in FIG. 10. In FIG. 10, the task placement device 4 is different from the task placement device 2 as the second exemplary embodiment of the present invention in the respect that the task placement device 4 includes a first task placement section 41 in substitution for the first task placement section 21, and further includes a task sort execution section 47. The first task placement section 41 includes a placement-target task retaining section 22, a control section 44, a scheduling information retaining section 25 and a placement result retaining section 26.

The task sort execution section 47 sequences each of tasks in a task set by sorting the tasks on the basis of task-set parameters. For example, the task sort execution section may perform topological sorting through which each of tasks is rearranged so as to be arranged anterior to any one of dependency-destination tasks associated with the each of the tasks on the basis of dependency relations among the tasks, which are included in the task-set parameters. Here, this topological sorting is a sorting method for sequencing each of nodes such that each of nodes (this node corresponding to the task in some aspects of the present invention) is arranged anterior to any one of its output side destinations (this output side corresponding to the dependency in some aspects of the present invention) in a directed acyclic graph. Through this sorting method, an arrangement of nodes is obtained. Thus, the control section 44 described below may sequentially select, as a placement-target task, each of tasks in arrangement order of the tasks. In addition, as an algorithm which realizes such a topological sorting, for example, an algorithm disclosed in a publicly known document, “Kahn, A. B. (1962), “Topological sorting of large networks” Communications of the ACM 5 (11): 558-562”, or an algorithm using the depth-first search is applicable.

The control section 44 sequentially selects, as a placement-target task, each of the tasks having been sequenced by the task sort execution section 47 in order from a first one of the tasks. Further, the control section 44 determines a final core allocation for a placement-target task on the basis of pieces of temporary scheduling information each associated with a corresponding one of cores. Specifically, the control section 44 calculates, for each of cores, a piece of temporary scheduling information in the case where a placement-target task is temporarily placed onto the core. Further, the control section 44 determines a final core allocation of the placement-target task on the basis of the pieces of temporary scheduling information each associated with a corresponding one of the cores. For example, the control section 44 may place a placement-target task onto a core for which the earliest temporary execution start clock time has been calculated.

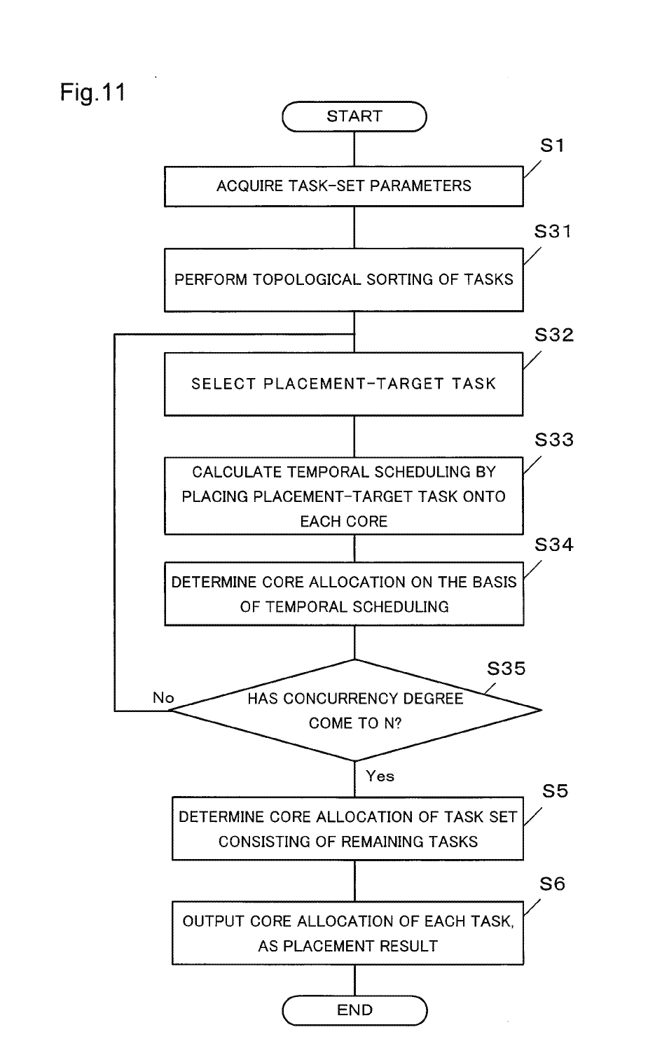

Operation of the task placement device 4 configured in such a way as described above will be described with reference to FIG. 11. In addition, here, it is assumed that the task sort execution section 47 performs topological sorting.

First, the task set parameter acquisition section 13 acquires task-set parameters for a task set which is a set of tasks constituting a targeted application (S1).

Next, the task sort execution section 47 performs topological sorting on tasks included in the task set on the basis of the task-set parameters (S31). In addition, in the case where it is already known that pieces of data included in the targeted task set are arranged in order resulting from topological sorting, the task sort execution section 47 can omit this process.

Next, the control section 44 selects a placement-target task and causes the placement-target task retaining section 22 to retain a piece of information indicating the selected placement-target task (S32). For example, when this process is carried out for the first time, the control section 44 may select, as a placement-target task, a first one of the tasks resulting from topological sorting. Further, when this process is carried out for the second and subsequent times, the control section 44 may select, as a new placement-target task, a task next to a task having been selected as a previous placement-target task.

Next, the control section 44 calculates, for the selected placement-target task, pieces of temporary scheduling information each associated with a corresponding one of cores. Further, the control section 44 causes the scheduling information retaining section 25 to retain the calculated pieces of temporary scheduling information (S33). Specifically, the control section 44 calculates, for each of the cores, a temporary execution start clock time and a temporary execution end clock time in the case where the placement-target task is temporarily placed onto the core. For example, the control section 44 may employ, as a temporary execution start clock time of the placement-target task, an execution end clock time of a dependency-source task corresponding to the placement-target task. Alternatively, in the case where a dependency-source task corresponding to the placement-target task has been placed on a core different from a core onto which the placement-target task is temporarily placed, the control section 44 may handle, as the temporary execution start clock time, a clock time resulting from adding overhead caused by a dependency between the cores to the execution end clock time of the dependency-source task. Further, the control section 44 may calculate, for each of the cores, the temporary execution end clock time by adding a required execution period of the placement-target task to the temporary execution start clock time of the placement-target task.

Next, the control section 44 determines a final core allocation of the placement-target task on the basis of the pieces of temporary scheduling information having been calculated in S33 (S34). For example, the control section 44 may determine, as the final core allocation of the placement-target task, an allocation to a core for which the earliest temporary execution start clock time has been calculated. Further, in the case where there is a plurality of cores which can be scheduled to the same execution start clock time, the control section 44 may determine, as the core allocation of the placement-target task, an allocation to a core having the smallest core serial number.

In addition, after the determination of the final core allocation of the placement-target task in the process of S34, the control section 44 may discard, among the pieces of temporary scheduling information having been calculated in the process of S33, pieces of temporary scheduling information related to cores other than a core having been determined in the final core allocation.

Next, the control section 44 determines whether or not the concurrency degree has come to N (S35). That is, the control section 44 determines whether or not there remains any core which is not executing any task.

In the case where, it is determined that the concurrency degree has not yet come to N (that is, there remains at least a core which is not executing any task), the first task placement section 41 repeats the processes from the process of S32 in which a next placement-target task is selected.

In contrast, in the case where, in the process of S35, it is determined that the concurrency degree has come to N (that is, there does not remain any core which is not executing any task), the first task placement section 41 terminates the task placement processing. Further, just like the processes of S5 to S6 in the first exemplary embodiment of the present invention, the second task acquisition section 12 performs task placement processing with respect to a task group consisting of remaining tasks having not been placed by the first task placement section 41, and outputs core allocations each associated with a corresponding of the tasks included in the targeted task set.

The above is the end of the operation of the task placement device 4.

It is to be noted that the process procedure having been described above is just an example, and the task placement device 4 may perform processing resulting from appropriately interchanging part of the aforementioned processes within a scope not departing from the gist of the present invention. Moreover, the task placement device 4 may appropriately perform concurrent processing with respect to part of the aforementioned processes within a scope not departing from the gist of the present invention.

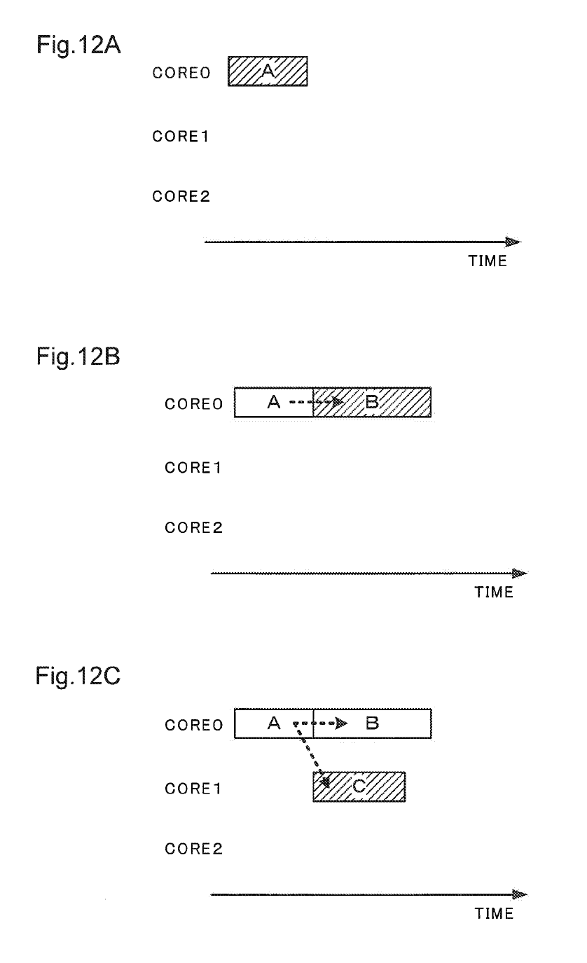

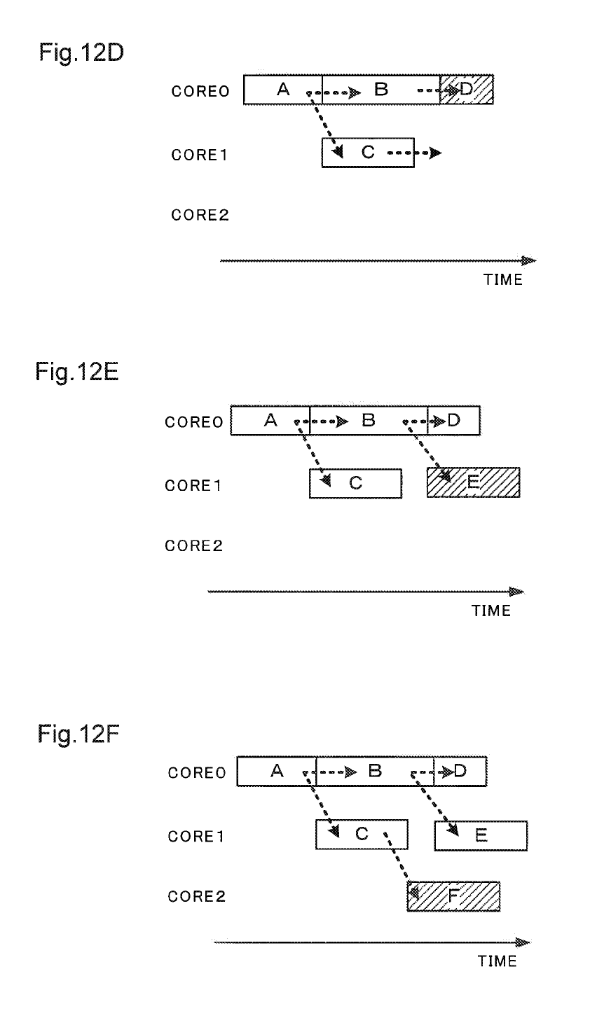

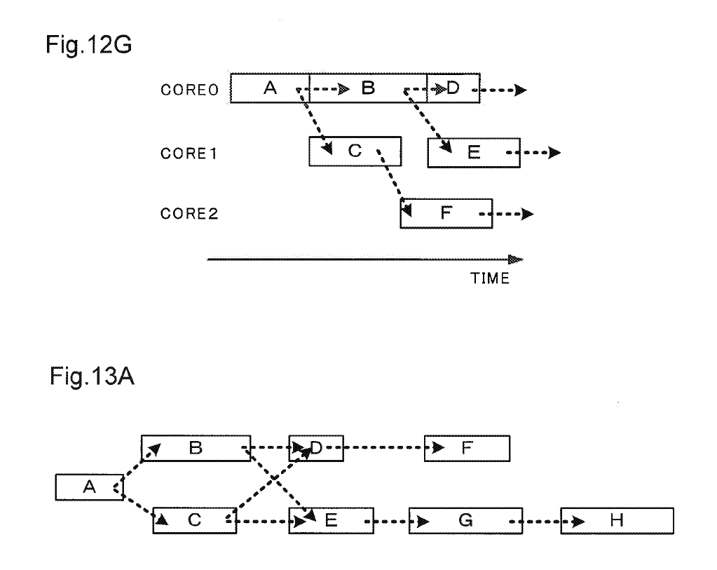

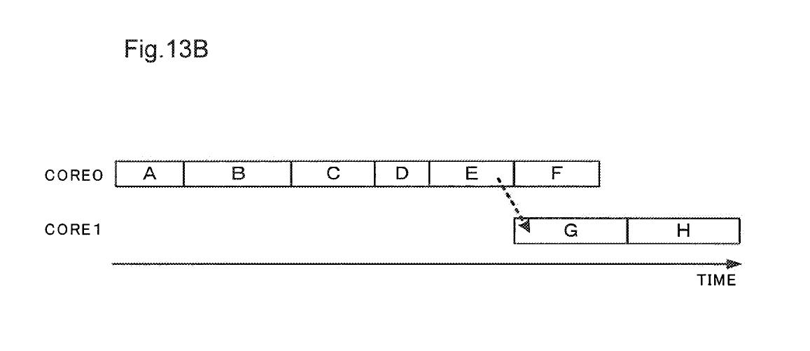

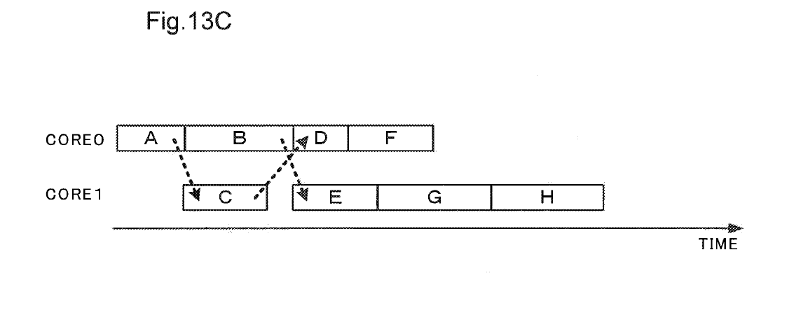

Next, a specific example of the operation of the task placement device 4 will be described with reference to FIG. 12. Here, the specific example of the operation of the task placement device 4 will be described using the task set, shown in FIG. 6, used in the description of the specific example of the operation of the task placement device 2 as the second exemplary embodiment of the present invention.

First, the task sort execution section 47 performs topological sorting on tasks included in the task set shown in FIG. 6, and outputs, as a result of the topological sorting, a piece of information representing an arrangement of tasks having been sequenced in order from the task A to the task J (S31). In accordance with the outputted piece of information, the control section 44 sequentially selects, as a placement-target task, each of the tasks in order from the task A to the task J (S32), and proceeds with task placement processing on the selected placement-target task.

<Placement Processing for Task A>

First, placement processing for the task A will be described with reference to FIG. 12A.

Here, first, the control section 44 calculates, for each of cores, a piece of temporary scheduling information related to the task A. In this case, for any one of the cores, a temporary execution start clock time of the task A becomes a task set execution start clock time, and a temporary execution end clock time of the task A becomes a clock time resulting from adding a required execution period of the task A to a task set execution start clock time (S33).

Thus, the control section 44 places the task A onto the core 0 having the smallest core serial number (S34). Here, the control section 44 may discard pieces of temporary scheduling information relating to the task A and have been calculated on the cores 1 and 2.

Next, the control section 44 determines that the concurrency degree is “1” and has not yet come to N which is equal to “3” (No in S35).

<Placement Processing for Task B>

Next, placement processing for the task B will be described with reference to FIG. 12B.

Here, first, the control section 44 calculates, for each of cores, a piece of temporary scheduling information related to the task B. In this case, since the task B is dependent on the task A, for any one of the cores, a temporary execution start clock time of the task B becomes an execution end clock time of the task A, and a temporary execution end clock time of the task B becomes a clock time resulting from adding a required execution period of the task B to the temporary execution start clock time of the task B (S33).

Thus, the control section 44 places the task B onto the core 0 having the smallest core serial number (S34). Here, the control section 44 may discard pieces of temporary scheduling information relating to the task B and having been calculated on the cores 1 and 2.

Next, the control section 44 determines that the concurrency degree is “1” and has not yet come to N which is equal to “3” (No in S35).

<Placement Processing for Task C>

Next, placement processing for the task C will be described with reference to FIG. 12C.

Here, first, the control section 44 calculates, for each of cores, a piece of temporary scheduling information related to the task C. In this case, the task C is dependent on the task A, but, at the execution end clock time of the task A, the task B has been already placed onto the core 0. As a result, for the core 0, a temporary execution start clock time of the task C becomes an execution end clock time of the task B. Further, for the cores 1 and 2, any other task is not placed onto the cores 1 and 2 at the execution end clock time of the task A, the temporary execution start clock time of the task C becomes the execution end clock time of the task A. Further, for each of the cores, a temporary execution end clock time of the task C becomes a clock time resulting from adding a required execution period of the task C to the temporary execution start clock time of the task C (S33).

Next, the control section 44 places the task C onto the core 1 having the smallest one of the core serial numbers of the cores 1 and 2 for which the earliest temporary execution start clock time has been calculated (S34). Here, the control section 44 may discard the pieces of temporary scheduling information relating to the task C and having been calculated on the cores 0 and 2.

Next, the control section 44 determines that the concurrency degree is “2” and has not yet come to N which is equal to “3” (No in S35).

<Placement Processing for Task D>

Next, placement processing for the task D will be described with reference to FIG. 12D.

Here, first, the control section 44 calculates, for each of cores, a piece of temporary scheduling information related to the task D. In this case, since the task D is dependent on the task B, for any one of the cores, a temporary execution start clock time of the task D becomes an execution end clock time of the task B, and a temporary execution end clock time of the task D becomes a clock time resulting from adding a required execution period of the task B to the temporary execution start clock time of the task B (S33).

Thus, the control section 44 places the task B onto the core 0 having the smallest core serial number (S34). Here, the control section 44 may discard pieces of temporary scheduling information relating to the task D and having been calculated on the cores 1 and 2.

Next, the control section 44 determines that the concurrency degree is “1” and has not yet come to N which is equal to “3” (No in S35).

<Placement Processing for Task E>

Next, placement processing for the task E will be described with reference to FIG. 12E.

Here, first, the control section 44 calculates, for each of cores, a piece of temporary scheduling information related to the task E. In this case, the task E is dependent on the task B but, for the core 0, the task D is already placed onto the core 0 at the execution end clock time of the task B. As a result, for the core 0, a temporary execution start clock time of the task E becomes an execution end clock time of the task D. Further, for the cores 1 and 2, any other task is not placed onto the cores 1 and 2 at the execution end clock time of the task B, the temporary execution start clock time of the task E becomes the execution end clock time of the task B. Further, for each of the cores, a temporary execution end clock time of the task E becomes a clock time resulting from adding a required execution period of the task E to the temporary execution start clock time of the task E (S33).

Next, the control section 44 places the task E onto the core 1 having the smallest one of the core serial numbers of the cores 1 and 2 for which the earliest temporary execution start clock time has been calculated (S34). Here, the control section 44 may discard the pieces of temporary scheduling information relating to the task E and having been calculated on the cores 0 and 2.

Next, the control section 44 determines that the concurrency degree is “2” and has not yet come to N which is equal to “3” (No in S35).

<Placement Processing for Task F>

Next, placement processing for the task F will be described with reference to FIG. 12F.

Here, first, the control section 44 calculates, for each of cores, a piece of temporary scheduling information related to the task F. In this case, the task F is dependent on the task C, but, for the core 0, the task B has been already placed onto the core 0 at the execution end clock time of the task C, and subsequently, the task D has been placed onto the core 0. As a result, for the core 0, a temporary execution start clock time of the task F becomes an execution end clock time of the task D. Further, for the core 1, although any other task has not been placed onto the core 1 at the execution end clock time of the task C, task placement processing has been already performed such that the execution of the task E starts before a clock time resulting from adding a required execution period of the task F to the execution end clock time of the task C. As a result, for the core 1, a temporary execution start clock time of the task F becomes an execution end clock time of the task E. Further, for the core 2, any other task is not placed onto the core 2 at the execution end clock time of the task C, a temporary execution start clock time of the task F becomes the execution end clock time of the task C. Further, for each of the cores, a temporary execution end clock time of the task F becomes a clock time resulting from adding a required execution period of the task F to the temporary execution start clock time of the task F (S33).

Next, the control section 44 places the task F onto the core 2 for which the earliest temporary execution start clock time has been calculated (S34). Here, the control section 44 may discard the pieces of temporary scheduling information relating to the task E and having been calculated on the cores 0 and 1.

Next, the control section 44 determines that the concurrency degree is “3” and has come to N which is equal to “3” (Yes in S35).

Through these processes described above, a task placement pattern, which utilizes three cores at an early stage immediately after a start of execution, can be obtained as shown in FIG. 12G. Here, the first task placement section 41 terminates the task placement processing.

In subsequent processes, the second task acquisition section 12 performs task placement processing by determining core allocations with respect to a task group consisting of remaining unplaced tasks including the tasks G, H, I and J shown in FIG. 6. In addition, as described above, the second task acquisition section 12 can use a task placement method which does not necessarily need any scheduling determination.

In addition, in this specific example, the description has been made on the assumption that there is no difference in an execution start clock time between a case where two tasks which have dependency relations with each other are each placed onto a corresponding one of different cores and a case where the two tasks are placed onto the same core. In the case where overhead of communication between cores is taken into consideration, the first task placement section 41 may set, as an execution start clock time of a placement-target task, a clock time resulting from adding the overhead of communication between cores.

Further, although the control section 44 terminates the task placement processing in the first task placement section 41 at the time when the concurrency degree has come to N in the process of S35, the control section 44 may terminate the task placement processing at the time when the concurrency degree has come to (N+1).

Further, in this exemplary embodiment, in the case where it is already known that tasks included in a target task set are arranged in order equivalent to order resulting from topological sorting, the task placement device does not need to include the task sort execution section.

Next, advantageous effects of this fourth exemplary embodiment of the present invention will be described.

The task placement device as this fourth exemplary embodiment of the present invention makes it possible to, for a multi-core system employing the AMP method and in which task scheduling is dynamically controlled, reduce an amount of core idle time and improve the performance of a targeted system.

A reason for this is because the task sort execution section sorts tasks included in a task set beforehand on the basis of task-set parameters, and while sequentially selecting, as a placement-target task, each of the sorted tasks in order from a first one of the sorted tasks, the first task placement section determines a core allocation and scheduling of the placement-target task on the basis of pieces of temporal scheduling information each obtained by temporarily placing the placement-target task which can be executed within a scheduling foreseeable period, which is a period until the concurrency degree becomes N, onto a corresponding one of cores. Further, this is because the second task acquisition section determines core allocations with respect to a task group consisting of remaining unplaced tasks.

Through this method, the task placement device as this exemplary embodiment makes it possible to, within a scheduling foreseeable period from an execution start clock time of a task set until the concurrency degree becomes N, sequentially allocate a core which can be scheduled at the earliest time point among N cores to each of tasks which are arranged in order resulting from sorting based on task-set parameters. In this way, the task placement device as this exemplary embodiment determines an appropriate core allocation on the basis of temporal execution clock times which are obtained by temporarily placing a placement-target task onto each of cores. In this way, the task placement device as this exemplary embodiment makes it possible to, for a multi-core system constituted of N cores, provide a task placement pattern which reduces a period from a start clock time of a task set until N tasks are concurrently executed such that each of the N tasks is executed by a corresponding one of the N cores as far as possible. Thus, as a result, the task placement device as this exemplary embodiment makes it possible to, for a multi-core system employing the AMP method, reduce an amount of core idle time and improve the performance of a targeted system by performing task placement processing which utilizes a plurality of cores at an early stage immediately after a start of execution.

It is to be noted here that the task placement device as each of the aforementioned exemplary embodiments of the present invention does not need to handle all of tasks to be executed in a targeted multicore system as placement targets in a lump. For example, the task placement device of each of the aforementioned exemplary embodiments may extract a series of tasks which are part of tasks to be executed in a targeted multi-core system and which are linked to one another through dependency relations.

Further, in each of the aforementioned exemplary embodiments of the present invention, the operation of the task placement device, having been described with reference to each of the flowcharts, is stored in advance in a storage device (a storage medium) of a computer device as the computer program according to an aspect of the present invention, and a relevant CPU may read and execute the computer program. Further, in such a case, the present invention has an aspect from the cords of the computer program as well as an aspect from a storage medium storing the computer program therein.

Further, the features of the individual aforementioned exemplary embodiments can be appropriately combined and carried out.

Further, the present invention is not limited to the individual aforementioned exemplary embodiments, and can be practiced in a variety of embodiments.

Further, part or the whole of the aforementioned exemplary embodiments can be described as, but not limited to, the following supplementary notes.

(Supplementary Note 1)

A task placement device including:

a task set parameter acquisition section configured to, for a task set which is a set of a plurality of tasks each being a target fixedly placed onto at least a processor core whose total number is N (N being an integer larger than or equal to one) and which is dynamically controlled while being executed with respect to scheduling of the tasks on the at least a processor core, acquire task-set parameters including at least a subset of pieces of information representing dependency relations among the tasks and a subset of required execution periods each required to complete execution of a corresponding one of the tasks;

a first task placement section configured to detect a scheduling foreseeable period within which the scheduling of the tasks on the at least a processor core after a start of execution of the task set is foreseeable in advance, and with respect to each of at least a first task which is among the tasks included in the task set and which becomes ready for execution within the scheduling foreseeable period, perform task placement processing by determining a core allocation in view of scheduling based on the task-set parameters; and

a second task placement section configured to, with respect to each of at least a second task which is among the tasks included in the task set and which is other than the at least a first task which is subjected to the task placement processing performed by the first task placement section, perform task placement processing by determining a core allocation based on the task-set parameters.

(Supplementary Note 2)

The task placement device according to supplementary note 1, wherein the first task placement section is configured to, with respect to a placement-target task which is made a placement target next within the scheduling foreseeable period, determine a core allocation and scheduling of the placement-target task on the basis of the task-set parameters and a task placement consideration clock time at which the placement-target task becomes ready for execution, and then, update the placement-target task and the task placement consideration clock time on the basis of the determined core allocation and scheduling.

(Supplementary Note 3)

The task placement device according to supplementary note 1 or 2, further including:

a task sort execution section configured to sequence the tasks included in the task set by sorting the tasks on the basis of the task-set parameters,

wherein the first task placement section is configured to, with respect to the tasks included in the task set, sequentially select, as the placement-target task, each of at least one of the tasks which becomes ready for execution within the scheduling foreseeable period, in order from a first one of tasks resulting from sequencing by the task sort execution section with respect to the tasks, and sequentially determine a core allocation and scheduling of the selected placement-target task on the basis of the task-set parameters.

(Supplementary Note 4)

The task placement device according to supplementary note 3,

wherein the first task placement section is configured to, for each of the at least a processor core, calculate temporary scheduling in a state of placing the placement-target task, which is selected in order from a first one of the sequenced tasks, onto the each of the at least a processor core, on the basis of the task-set parameters and scheduling of each of at least a task which is among the sequenced tasks and which has been already placed, and then, determine a core allocation and scheduling of the placement-target task on the basis of the calculated temporary scheduling with respect to each of the at least a processor core.

(Supplementary Note 5)

The task placement device according to supplementary note 3 or supplementary note 4,

wherein the task sort execution section sequences the tasks by using a topological sorting method.

(Supplementary Note 6)

The task placement device according to any one of supplementary notes 1 to 5,

wherein the first task placement section detects, as the scheduling foreseeable period, a period from a start of execution of the task set until a concurrency degree becomes N.

(Supplementary Note 7)

The task placement device according to any one of supplementary notes 1 to 5,

wherein the first task placement section detects, as the scheduling foreseeable period, a period from a start of execution of the task set until a concurrency degree becomes (N+1).

(Supplementary Note 8)

A task placement method including:

for a task set which is a set of a plurality of tasks each being a target fixedly placed onto at least a processor core whose total number is N (N being an integer larger than or equal to one) and which is dynamically controlled while being executed with respect to scheduling of the tasks on the at least a processor core, acquiring task-set parameters including at least a subset of pieces of information representing dependency relations among the tasks and a subset of required execution periods each required to complete execution of a corresponding one of the tasks;

performing first task placement processing for detecting a scheduling foreseeable period within which the scheduling of the tasks on the at least a processor core after a start of execution of the task set is foreseeable in advance, and determining a core allocation in view of scheduling based on the task-set parameters with respect to each of at least a first task which is among the tasks included in the task set and which becomes ready for execution within the scheduling foreseeable period; and

performing second task placement processing for determining a core allocation based on the task-set parameters with respect to each of at least a second task which is among the tasks included in the task set and which is other than the at least a first task which is subjected to the first task placement processing.

(Supplementary Note 9)

The task placement method according to supplementary note 8, wherein, when the first task placement processing is performed, with respect to a placement-target task which is made a placement target next within the scheduling foreseeable period, a core allocation and scheduling of the placement-target task are determined on the basis of the task-set parameters and a task placement consideration clock time at which the placement-target task becomes ready for execution, and then, the placement-target task and the task placement consideration clock time are updated on the basis of the determined core allocation and scheduling.

(Supplementary Note 10)

The task placement method according to supplementary note 8 or supplementary note 9,

wherein the tasks included in the task set are sequenced by sorting the tasks on the basis of the task-set parameters, and

wherein, when the first task placement processing is performed, with respect to the tasks included in the task set, each of at least one of the tasks which becomes ready for execution within the scheduling foreseeable period is sequentially selected as the placement-target task in order from a first one of tasks resulting from sequencing the tasks, and a core allocation and scheduling of the selected placement-target task are sequentially determined on the basis of the task-set parameters.

(Supplementary Note 11)

A computer program that causes a computer to execute processing including:

for a task set which is a set of a plurality of tasks each being a target fixedly placed onto at least a processor core whose total number is N (N being an integer larger than or equal to one) and which is dynamically controlled while being executed with respect to scheduling of the tasks on the at least a processor core, acquiring task-set parameters including at least a subset of pieces of information representing dependency relations among the tasks and a subset of required execution periods each required to complete execution of a corresponding one of the tasks;

performing first task placement processing for detecting a scheduling foreseeable period within which the scheduling of the tasks on the at least a processor core after a start of execution of the task set is foreseeable in advance, and determining a core allocation in view of scheduling based on the task-set parameters with respect to each of at least a first task which is among the tasks included in the task set and which becomes ready for execution within the scheduling foreseeable period; and

performing second task placement processing for determining a core allocation based on the task-set parameters with respect to each of at least a second task which is among the tasks included in the task set and which is other than the at least a first task which is subjected to the first task placement processing.

(Supplementary Note 12)

The computer program according to supplementary note 11, wherein, in the first task placement processing, with respect to a placement-target task which is made a placement target next within the scheduling foreseeable period, a core allocation and scheduling of the placement-target task are determined on the basis of the task-set parameters and a task placement consideration clock time at which the placement-target task becomes ready for execution, and then, the placement-target task and the task placement consideration clock time are updated on the basis of the determined core allocation and scheduling.

(Supplementary Note 13)

The computer program according to supplementary note 11 and supplementary note 12,

wherein the computer device is caused to further execute task sort processing for sequencing the tasks included in the task set by sorting the tasks on the basis of the task-set parameters, and

wherein, in the first task placement processing, with respect to the tasks included in the task set, each of at least one of the tasks which becomes ready for execution within the scheduling foreseeable period is sequentially selected as the placement-target task in order from a first one of tasks resulting from sequencing the tasks, and a core allocation and scheduling of the selected placement-target task are sequentially determined on the basis of the task-set parameters.

Hereinbefore, the present invention has been described by way of a reference to embodiments (and practice examples), but is not limited to the aforementioned exemplary embodiments (and the practice examples). Various changes which can be understood by those skilled in the art can be made on the configuration and the details of the present invention within a scope of the present invention.

This application is based upon and claims the benefit of priority from Japanese patent application No. 2012-094392, filed on Apr. 18, 2012, the disclosure of which is incorporated herein in its entirety by reference.

### REFERENCE SIGNS LIST

1, 2, 3 and 4: Task placement device
11, 21, 31 and 41: First task placement section
12: Second task acquisition section
13: Task set parameter acquisition section
22: Placement target task retaining section
23: Task placement consideration clock time retaining section
24, 34 and 44: Control section
25: Scheduling information retaining section
26: Placement result retaining section
47: Task sort execution section
1001: CPU
1002: RAM
1003: ROM
1004: Storage device

What is claimed is:

1. A task placement device comprising:
a task set parameter acquisition section configured to, for a task set which is dynamically controlled while being executed with respect to scheduling of tasks on at least a processor core, acquire task-set parameters including at least a subset of pieces of information representing dependency relations among the tasks and a subset of required execution periods each required to complete execution of a corresponding one of the tasks;
a first task placement section configured to, with respect to each of at least a first task which is among the tasks included in the task set and which becomes ready for execution within the scheduling foreseeable period, perform task placement processing by determining a core allocation in view of scheduling based on the task-set parameters; and
a second task placement section configured to, with respect to a task except the first task performed by the first task placement section, perform task placement processing by determining a core allocation based on the task-set parameters.

2. The task placement device according to claim 1,
wherein the first task placement section is configured to, with respect to a placement-target task which is made a placement target next within the scheduling foreseeable period, determine a core allocation and scheduling of the placement-target task on the basis of the task-set parameters and a task placement consideration clock time at which the placement-target task becomes ready for execution, and then, update the placement-target task and the task placement consideration clock time on the basis of the determined core allocation and scheduling.

3. The task placement device according to claim 1, further comprising
a task sort execution section configured to sequence the tasks included in the task set by sorting the tasks on the basis of the task-set parameters,
wherein the first task placement section is configured to, with respect to the tasks included in the task set, sequentially select, as the placement-target task, each of at least one of the tasks which becomes ready for execution within the scheduling foreseeable period, in order from a first one of tasks resulting from sequencing by the task sort execution section with respect to the tasks, and sequentially determine a core allocation and scheduling of the selected placement-target task on the basis of the task-set parameters.

4. The task placement device according to claim 3,
wherein the first task placement section is configured to, for each of the at least a processor core, calculate temporary scheduling in a state of placing the placement-target task, which is selected in order from a first one of the sequenced tasks, onto the each of the at least a processor core, on the basis of the task-set parameters and scheduling of each of at least a task which is among the sequenced tasks and which has been already placed, and then, determine a core allocation and scheduling of the placement-target task on the basis of the calculated temporary scheduling with respect to each of the at least a processor core.

5. The task placement device according to claim 3,
wherein the task sort execution section sequences the tasks by using a topological sorting method.

6. The task placement device according to claim 1,
wherein the first task placement section detects, as the scheduling foreseeable period, a period from a start of execution of the task set until a concurrency degree becomes N.

7. The task placement device according to claim 1,
wherein the first task placement section detects, as the scheduling foreseeable period, a period from a start of execution of the task set until a concurrency degree becomes (N+1).

8. A task placement method comprising:
for a task set which is dynamically controlled while being executed with respect to scheduling of tasks on at least a processor core, acquiring task-set parameters including at least a subset of pieces of information representing dependency relations among the tasks and a subset of required execution periods each required to complete execution of a corresponding one of the tasks;
performing first task placement processing for determining a core allocation in view of scheduling based on the task-set parameters, with respect to each of at least a first task which is among the tasks included in the task set and which becomes ready for execution within the scheduling foreseeable period; and
performing second task placement processing for determining a core allocation based on the task-set parameters, with respect to task except the at least a first task which is subjected to the first task placement processing.

9. The task placement method according to claim 8, wherein, when the first task placement processing is performed, with respect to a placement-target task which is made a placement target next within the scheduling foreseeable period, a core allocation and scheduling of the placement-target task are determined on the basis of the task-set parameters and a task placement consideration clock time at which the placement-target task becomes ready for execution, and then, the placement-target task and the task placement consideration clock time are updated on the basis of the determined core allocation and scheduling.

10. A non-transitory computer readable medium stores a program causing a computer to execute processing comprising:
for a task set which is dynamically controlled while being executed with respect to scheduling of the tasks on at least a processor core, acquiring task-set parameters including at least a subset of pieces of information representing dependency relations among the tasks and a subset of required execution periods each required to complete execution of a corresponding one of the tasks;
performing first task placement processing for determining a core allocation in view of scheduling based on the task-set parameters with respect to each of at least a first task which is among the tasks included in the task set and which becomes ready for execution within the scheduling foreseeable period; and
performing second task placement processing for determining a core allocation based on the task-set parameters with respect to a task except the at least a first task which is subjected to the first task placement processing.

11. A task placement device comprising:
a task set parameter acquisition section means for, for a task set which is dynamically controlled while being executed with respect to scheduling of tasks on the at least a processor core, acquiring task-set parameters including at least a subset of pieces of information representing dependency relations among the tasks and a subset of required execution periods each required to complete execution of a corresponding one of the tasks;
a first task placement section means for, with respect to each of at least a first task which is among the tasks included in the task set and which becomes ready for execution within the scheduling foreseeable period, performing task placement processing by determining a core allocation in view of scheduling based on the task-set parameters; and
a second task placement section means for, with respect to a task except the a first task performed by the first task placement section, performing task placement processing by determining a core allocation based on the task-set parameters.
